(19) United States
(12) Patent Application Publication
(10) Pub. No.: US 2026/0162332 A1
(43) Pub. Date: Jun. 11, 2026

(54) METHOD AND SYSTEM TO DEFINE A REAL-TIME CUSTOMIZATION MODEL FOR CONFIGURING AN ENTERPRISE WEB-APPLICATION

(71) Applicant: Oracle International Corporation, Redwood Shores, CA (US)

(72) Inventors: Volodymyr Ushenko, Vancouver (CA); Kaarthik Balasubrahmanian, San Jose, CA (US); Donald Creig Humes, Yorktown, VA (US); Ramesh Kumaraswami, Austin, TX (US); Sridhar Tadepalli, Frisco, TX (US); Saravanan Anandan, Redwood Shores, CA (US); Kartik Raghavan, Redwood Shores, CA (US)

(73) Assignee: Oracle International Corporation, Redwood Shores, CA (US)

(21) Appl. No.: 19/179,905

(22) Filed: Apr. 15, 2025

Related U.S. Application Data
(60) Provisional application No. 63/678,242, filed on Aug. 1, 2024.

(51) Int. Cl. G06T 11/60; G06F 9/451

(52) U.S. Cl. CPC G06T 11/60; G06F 9/451; G06T 2200/24

(57) ABSTRACT

A system, method, and non-transitory computer-readable media are provided for using a consumer-agnostic file to make and view changes to an interface that can be published for viewing by other users. A published version of the consumer-agnostic file may be accessed from a server. The consumer-agnostic file defines components of a customized user interface as identified among a structured set of keys. The keys are associated with corresponding interface regions and/or characteristics of the components. The components may be defined based on fields of a record, such as a record selected for view when the user interface is rendered. The user interface may allow switching between a configuration mode of the customized user interface where the customized user interface may be modified and a rendering mode of the customized user interface where the customized user interface may be viewed, optionally without re-accessing the published version of the consumer-agnostic file from the server. A modified version of the consumer-agnostic file may be published to the server.

### CROSS REFERENCE TO RELATED APPLICATIONS

This application claims the benefit of U.S. Provisional Ser. No. 63/678,242, filed on Aug. 1, 2024. The entire disclosure of the aforementioned application is incorporated by reference herein in its entirety for all purposes.

### BACKGROUND

Organizations develop customized user interfaces for applications to support processes that are unique to the organizations. These interfaces are displayed in a variety of form factors, on laptops, desktops, mobile devices, and tablets. The interfaces may be designed through an iterative process of saving, reviewing, saving again, and reviewing again. This process may be cumbersome, slow down interface design, and prevent some business users from being able to effectively use interface design tools for customized purposes.

### BRIEF SUMMARY

In some embodiments, a computer-implemented method includes using a consumer-agnostic file to make and view changes to an interface that can be published for viewing by other users. A published version of the consumer-agnostic file may be accessed from a server. The consumer-agnostic file defines components of a customized user interface as identified among a structured set of keys. The keys are associated with corresponding interface regions and/or characteristics of the components. The components may be defined based on fields of a record, such as a record selected for view when the user interface is rendered. The user interface may allow switching between a configuration mode of the customized user interface where the customized user interface may be modified and a rendering mode of the customized user interface where the customized user interface may be viewed, optionally without re-accessing the published version of the consumer-agnostic file from the server. A modified version of the consumer-agnostic file may be published to the server.

In one embodiment, a computer-implemented method comprises rendering, by a client device, a customized user interface for viewing information about a record at least in part by: accessing, from a server, a published version of a consumer-agnostic file that defines a plurality of components of the customized user interface. The plurality of components are identified among a structured set of keys. One or more keys of the structured set of keys are associated with one or more corresponding interface regions and one or more other keys of the structured set of keys are associated with one or more characteristics of one or more components of the plurality of components. The one or more components are defined based at least in part on one or more fields of the record. The rendering further comprises accessing, from the server, one or more values of the one or more fields from the record, and generating one or more graphical elements in the one or more corresponding interface regions based at least in part on the one or more values and the one or more characteristics of the one or more components. The computer-implemented method further comprises switching to a configuration mode of the customized user interface, and saving, in memory of the client device, an identity of the record. The computer-implemented method further comprises receiving input to make one or more changes to the consumer-agnostic file. The computer-implemented method further comprises storing the one or more changes in memory of the client device as a new version of the consumer-agnostic file without updating the published version of the consumer-agnostic file. The computer-implemented method further comprises switching to a rendering mode of the customized user interface. The computer-implemented method further comprises loading the new version of the consumer-agnostic file from memory without re-retrieving the published version of the consumer-agnostic file from the server. The computer-implemented method further comprises rendering, by the client device, the customized user interface based at least in part on one or more values from the record and the new version of the consumer-agnostic file. The computer-implemented method further comprises publishing a changed version of the consumer-agnostic file to replace the published version of the consumer-agnostic file, wherein publishing causes the changed version of the consumer-agnostic file to be newly accessible to one or more other users.

In a further embodiment, the plurality of components comprise a plurality of view components each comprising one or more section components, and the one or more characteristics indicate which user interface functionality of a plurality of candidate user interface functionalities is used to switch between viewing the plurality of view components.

In the same or a different further embodiment, the plurality of components comprise a plurality of section components each comprising one or more field components, and the one or more characteristics indicate how to arrange the one or more field components within the plurality of section components.

In the same or a different further embodiment, the plurality of components comprise a plurality of section components, and the one or more characteristics indicate which user interface functionality of a plurality of candidate user interface functionalities is used to concurrently view the plurality of section components.

In the same or a different further embodiment, the plurality of components comprise a line item grid, and the one or more characteristics indicate which records to include in the line item grid and which columns of the records to show in the line item grid.

In the same or a different further embodiment, the plurality of components comprise an action component specified, in the consumer-agnostic file, as appearing directly in the customized user interface or as appearing in a drill-down menu of the customized user interface. The action component is nested under one or more keys of the structured set of keys and causes performance of a process defined for the action component.

In the same or a different further embodiment, the plurality of components comprise a visualization component nested under one or more keys of the structured set of keys, and the one or more characteristics indicate one or more columns that are featured in a visualization triggered by the visualization component.

In the same or a different further embodiment, the plurality of components comprise a visualization component nested under one or more keys of the structured set of keys, and the one or more characteristics indicate one or more types of visualizations of a plurality of candidate types of visualizations.

In the same or a different further embodiment, the plurality of components comprise an approval component to transition to an approved status, and the one or more characteristics identify one or more approvers that can accomplish the transition via the customized user interface.

In the same or a different further embodiment, the computer-implemented method further comprises, before publishing the changed version, receiving, at the server, the new version of the consumer-agnostic file from the client device. The computer-implemented method further comprises, before publishing the changed version, saving, by the server, the new version of the consumer-agnostic file as a staged version of the consumer agnostic file. The computer-implemented method further comprises, before publishing the changed version, marking one or more other versions of the consumer-agnostic file on one or more other client devices as dirty. The computer-implemented method further comprises, before publishing the changed version, receiving one or more other changes to the consumer-agnostic file from one or more other client devices. The computer-implemented method further comprises, before publishing the changed version, generating the changed version based at least in part on the one or more changes and the one or more other changes.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that uses a consumer-agnostic file to make and view changes to an interface that can be published for viewing by other users.

FIG. 2 illustrates a system diagram showing an example infrastructure for using a consumer-agnostic file to make and view changes to an interface that can be published for viewing by other users.

FIG. 3A shows an example configuration user interface that includes options to adjust characteristic(s) of a field, Transaction Name, by selecting whether the field takes full row width and/or whether a description is shown when the field is displayed.

FIG. 3B shows an example configuration user interface that includes options to edit an attribute directly and specify additional details and restrictions for the attribute.

FIG. 3C shows an example configuration user interface that includes a selected option to use a layout characteristic for displaying four columns of fields in a section.

FIG. 3D shows an example configuration user interface that includes a selected option to use a layout characteristic for displaying fields reactively based on the amount of data contained in the field.

FIG. 3E shows an example configuration user interface that includes a selected option to use a layout characteristic for displaying one columns of fields in a section.

FIG. 3F shows an example configuration user interface that includes a selected option to use a layout characteristic for displaying two columns of fields in a section.

FIG. 3G shows an example configuration user interface that includes a selected option to use a layout characteristic for displaying three columns of fields in a section.

FIG. 3H shows an example configuration user interface that includes an option to select a style characteristic where sections can be collapsed or expanded to show field(s) within the sections.

FIG. 3I shows an example configuration user interface that includes an option to select a style characteristic where sections are selectable to be displayed alternately in horizontal tabs, where views are also selectable in horizontal tabs.

FIG. 3J shows an example configuration user interface that includes an option to select a style characteristic where sections are selectable to be displayed alternately in vertical tabs, where views are selectable in horizontal tabs.

FIG. 3K shows an example configuration user interface that includes an option for selecting from available fields using a natural language input.

FIG. 3L shows an example configuration user interface that includes an option being used to select from among available fields shown that are matching, partially matching, or semantically similar to a natural language input.

FIG. 3M shows an example configuration user interface that includes an option being used to select a particular field shown that is matching, partially matching, or semantically similar to a natural language input.

FIG. 3N shows an example configuration user interface that includes an option being used to select a particular field shown based on natural language input.

FIG. 3O shows an example configuration user interface that includes an option being used to drag a particular field selected using a natural language input into a particular position in a user interface, where the particular field will be shown if the example configuration user interface is transitioned to interface rendering mode.

FIG. 3P shows an example configuration user interface that includes an option being used to select a particular action to perform when a save option is selected for input to the natural language input region.

FIG. 3Q shows an example configuration user interface that includes an option showing selection of a save action to perform when a save option is selected and an email action to perform when an email option is selected for input to the natural language input region.

FIG. 4 shows an example configuration user interface that includes an option for showing a grid of items where columns are selectable for inclusion in the grid and columns are individually selectable as editable or not editable.

FIG. 5A shows an example rendered user interface of a line item grid showing one item.

FIG. 5B shows an example rendered user interface that includes an option in interface rendering mode being used to select a particular field shown that is matching, partially matching, or semantically similar to a natural language input.

FIG. 5C shows an example rendered user interface that includes an option in interface rendering mode to edit a ship to address that is used in or behind-the-scenes for one or more interfaces that are part of a hierarchical or navigable interface.

FIG. 5D shows an example rendered user interface that includes an option in interface rendering mode to make an update that began with natural language user input.

FIG. 6 shows an example user interface rendering of a plurality of other or secondary actions in addition to one primary save action in a header.

FIG. 7 shows an example user interface rendering of another or secondary action in addition to one primary get account details action for a Customer Info view.

FIG. 8 shows an example user interface that includes an rendering of a visualization option in the Quote Info view.

FIG. 9 shows an example of a visualization configuration interface for selecting visualizations to be applied when the visualization option is selected. Each visualization may be further customized to select record(s) and/or column(s) to be included in the visualization.

FIG. 10 depicts a simplified diagram of a distributed system for implementing certain aspects.

FIG. 11 is a simplified block diagram of one or more components of a system environment by which services provided by one or more components of an embodiment system may be offered as cloud services, in accordance with certain aspects.

FIG. 12 illustrates an example computer system that may be used to implement certain aspects.

### DETAILED DESCRIPTION

A description of using a consumer-agnostic file to make and view changes to an interface that can be published for viewing by other users is provided in the following sections:
CONFIGURATION, PRICE, QUOTE APPLICATIONS
UPDATING USER INTERFACES AND APPLICATIONS
INTERFACE CONFIGURATION MODE
CONSUMER-AGNOSTIC FILE
SEAMLESS SWITCHING BETWEEN INTERFACE CONFIGURATION MODE AND INTERFACE RENDERING MODE
EFFICIENT FETCHING USING THE CONSUMER-AGNOSTIC FILE AND FUNCTIONALITY-DRIVEN KEYS IN A HIERARCHY OF KEYS
PUBLICATION OF CONSUMER-AGNOSTIC FILE OR UPDATES THERETO TO CLIENTS OF A CLOUD APPLICATION
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Configuration, Price, Quote Applications

In one embodiment, a configuration, price, quote (CPQ) application is used by sales personnel to create quotes, manage product or service configurations, determine what configurations and offerings are available based on inventory and variations available, promotions, and current packages or offerings, provide quotes for products or services, obtain approvals to send out the quote, and finalize sales and manage orders with customers. In order to manage quote generation activities efficiently and effectively for an individual organization, the organization may create custom interfaces that sales personnel can use to suggest product configurations, obtain approvals, and generate quotes for customers. The organization may want to surface certain functionality, information, or visualizations for sales personnel at the time of providing a quote, and/or may want to trigger certain automation for sales personnel at the time of entering data for a quote, obtaining approvals, or providing the quote. An administrator or other privileged user of the organization may configure an interface that sales personnel can use to suggest product configurations, obtain approvals, and generate quotes.

Access to the configuration interface may be limited based on user roles, for example, and access even to the rendering interface or viewing interface may be limited based on user roles. Publication of changes made in the configuration interface may be pushed to all users with access to the rendering or viewing interface or to only a subset of users. The configuring user may select which roles are assigned to view the updated interface and which roles are not assigned and not allowed to view the updated interface, and the interface management system restricts access based on the role-based access settings.

Due to the fast-paced environment of optimizing configurations, prices, and the quote process to adapt to customer needs and market realities, organizations may wish to make rapid changes to the quote process. These changes may surface different information, different functionality, different visualizations, or trigger different automations depending on the changing needs of the business in cycling through their finite inventory, their limited-time promotions, and their cyclic business expectations. This fast-paced environment could benefit from less fixed interfaces that can change depending on the scenario and the changing emphases of the organization over even short periods of time.

In various embodiments, other applications beyond configuration, price, quote systems have similar needs that would benefit from more seamless and rapid updates of user interfaces that allow users to continue using the application as updated without interruption, and that allow the configuring users to have visibility into what the changes are. Other applications such as supply chain management, human capital management, financial tools, internet of things management platforms, application management tools, or other tools may benefit from more rapid update cycles and more fluid and frequently changing interfaces to fit changing organization needs.

### Updating User Interfaces and Applications

Customers may customize and/or extend their enterprise (CPQ) application(s). The nature of these customizations and/or extensions could include introducing a new workflow, modifying an existing workflow, adding or modifying a business attribute or an action, customizing application page layouts, changing application configurations, updating application settings and the like. Whenever these extensions and/or customizations are made to the application via cloud-based application configuration tooling, the changes are applied on an existing application running on an end-users' client device so that the device may also see the extensions and/or customizations. In some interface management systems, making such changes may include either releasing a new version of the application that involves a re-installation or re-deployment of the product on the client devices, or loading the extension using a mechanism that could potentially disrupt the user's activity and workflow. Regardless of the method for updating the application, the new changes are merged with prior customizations to form an updated version of the application, such as a custom quoting system updated to account for a change in the business process.

As an alternative to re-installation, re-deployment, or heavyweight extensions, interface management systems may manage changes using a more lightweight process that uses a consumer-agnostic file or data structure to store individualized preferences for what the interface should include and how the interface should look. In one embodiment, an interface management system such as an enterprise web-application system (for example, CPQ (Configure, Price, Quote) software) includes an interface configuration mode and a rendered interface mode. The interface management system allows administrators or other privileged users to efficiently create and customize the layout used to render quoting flows for sales representatives. The interface management system allows privileged users to seamlessly switch between the interface configuration mode, where they can customize the layout with intuitive drag-and-drop tools and configuration options, and the rendered interface mode, where they can instantly preview their changes as they would appear in the actual quoting environment. For example, the interface management system may include a button to toggle in real-time between configuring the interface and viewing the interface from the perspective of a viewing user, without committing the interface to a permanent repository or even to a server-side sandbox until the changes as entered have been confirmed to appear correctly and be ready for publication. This real-time toggling capability enhances the flexibility and responsiveness of quote page customization, allowing administrators to immediately see the impact of their modifications, ensure optimal layout design, and streamline the overall configuration process.

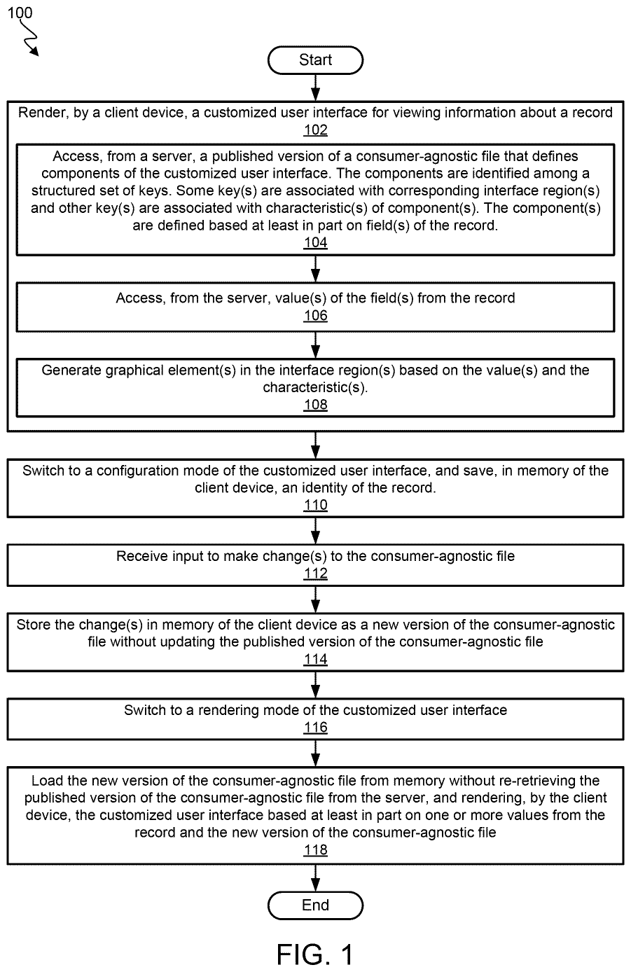

FIG. 1 illustrates a flow chart of an example process 100 that uses a consumer-agnostic file to make and view changes to an interface that can be published for viewing by other users. As shown, in block 102, a client device renders a customized user interface for viewing information about a record. Block 102 includes blocks 104-108 in the example shown. In block 104, the client device accesses, from a server, a published version of a consumer-agnostic file that defines components of the customized user interface. The components are identified among a structured set of keys. Some key(s) are associated with corresponding interface region(s) and other key(s) are associated with characteristic(s) of component(s). The component(s) are defined based at least in part on field(s) of the record. In block 106, the client device accesses, from the server, value(s) of the field(s) from the record. In block 108, graphical element(s) are generated in the interface region(s) based on the value(s) and the characteristic(s).

Process 100 proceeds to block 110, in which a switch is made to a configuration mode of the customized user interface, and the client device saves, in memory, an identity of the record. In block 112, the client device receives input to make change(s) to the consumer-agnostic file. In block 114, the change(s) are stored in memory of the client device as a new version of the consumer-agnostic file without updating the published version of the consumer-agnostic file. In block 116, another switch is made, to a rendering mode of the customized user interface. In block 118, the client device loads the new version of the consumer-agnostic file from memory without re-retrieving the published version of the consumer-agnostic file from the server, and renders the customized user interface based at least in part on one or more values from the record and the new version of the consumer-agnostic file.

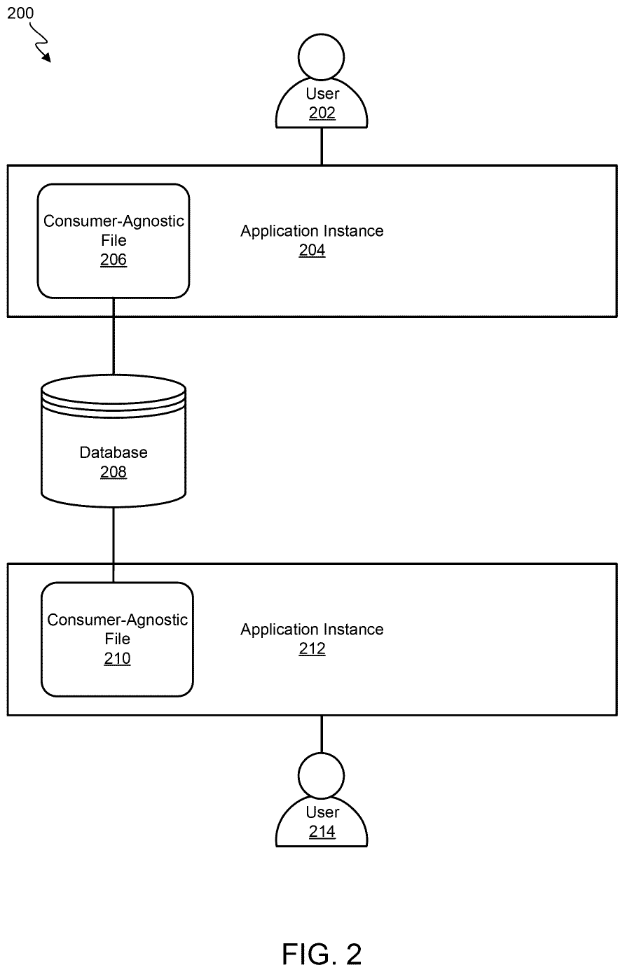

FIG. 2 illustrates a system diagram showing an example infrastructure for using a consumer-agnostic file to make and view changes to an interface that can be published for viewing by other users. As shown, user 202 interacts with application instance 204 using an interface configuration mode to modify consumer-agnostic file 206. Consumer-agnostic file 206 is published to database 208, and application instance 212 retrieves consumer-agnostic file 210 from database 208 to show a corresponding interface to user 214.

In one embodiment, the interface management system uses technology-and/or platform-and/or framework-agnostic definition file(s). The definition file(s) may be identified by a specific application version number, which can be modified and/or extended to seamlessly reflect changes done to the application state at run-time. The definition file(s) are customized artifact(s) that may be stored in memory at a location identified by a first universal identifier. The definition file(s) may be stored in memory in an application session of a configuring user and may remain in the memory of the application session without being persisted beyond the memory of the application session, such as to a sandbox or production system, unless and until the definition file(s) are published for other users to view.

The application session may exist between a browser or other logic executing on a client device of the configuring user and an instance of the application running for an application server. The application session may include details about what is being rendered on the user's screen, how long the user has been connected to the application, a history of interactions between the user and the application since becoming connected, and any other information that is helpful to providing application services to the user during the connection with the application instance. Information stored in an application session may be persisted outside the bounds of the application session or may be destroyed when the application session is closed. In one embodiment, some details about the connection between the application instance and the client are persisted outside the bounds of the session, and other details about the connection between the application instance and the client are destroyed when the client closes the connection with the application instance.

The application may be configured to use the definition file(s) from memory to view changes to the interface that are being configured, as if the changes were viewed by a viewing user without configuration capabilities. Even if the definition file(s) have not changed during the application session, the application may be configured to use the definition file(s) retrieved from the application server or a database accessible to the application, or retrieved from memory as previously retrieved definition file(s), to view the interface in the application session. In this manner, both the interface and the ability to change the interface exist within the application session and do not need to be published or persisted outside the application session to obtain the benefit of viewing the interface as if the interface is being viewed by a non-configuring user.

In one embodiment, changes that are made during the application session are persisted in the application session as the configuring user toggles back-and-forth between interface configuration mode and interface rendering mode, and the changes may either be committed to the application server or database accessible to the application outside the bounds of the application session if the user has chosen to publish the changes to the interface for other users to view. If the user has not chosen to publish the changes to the interface for other users to view, the changes may remain within the bounds of the application session and may be destroyed when the application session is closed. When the configuring user logs back in to the application session after the session has been closed, the configuring user may return to see changes that were in-flight and saved in association with the session or may see the interface as if the changes that were made in the previous session never existed. In the latter scenario, the changes in the previous session may have been destroyed at the end of the application session or persisted for activity logging purposes but not for configuration purposes.

In one embodiment, in-flight changes that have been made but have not yet been published are saved in association with a staging area that is visible to different configuring users. In this embodiment, the in-flight changes may be viewed by the different configuring users in the different sessions, but the in-flight changes are not loaded by other users when establishing a standard application session for a standard viewing user. The other users see the interface as if the changes did not exist, as the staging area is not visible to the other users. In this embodiment, any of the configuring users may publish the changes, and one or several different configuring users may have contributed to the changes that are eventually published, in same or different application sessions.

Upon publication, the definition file(s) stored in association with the configuring user(s) session(s) are moved to a production area that stores definition file(s) for standard viewing users, or a pointer for a location of the definition file(s) for the production area may be re-mapped to point to the definition file(s) that were previously pointed to for the staging area. At that point, the staging area may be cleared or otherwise be a copy of the definition file(s) that exist in the production area, until further yet-to-be-published changes are made.

In one embodiment, the interface rendering mode retains information about which record(s) are being viewed by or on behalf of which user(s) (for example, if the viewing user is viewing a record on behalf of another user, or invoking the privileges of a lower-privileged user to see how a record might look to the lower-privileged user). Access to the configuration interface and the ability to view the interface on behalf of other users may be limited based on user roles, for example, with some roles being able to view on behalf of other roles or, in the case of an administrator, on behalf of any role. The information about which record(s) are being viewed may be persisted as the interface management system switches between interface rendering mode and interface configuration mode, such that switching back to interface rendering mode allows the previously configuring and now viewing user to view the same record(s) that were being viewed in interface rendering mode before the interface configuration mode was entered, and on behalf of the same user(s) that were being used to simulate the view of the record(s) before the interface configuration mode was entered.

Switching from the interface rendering mode to the interface configuration mode causes display of an interface for configuring a view and/or sections that are relevant to the latest record(s) that were being viewed in interface rendering mode, but the modification to the view and/or sections may be made to all records that incorporate the view and/or sections using the same application navigation pathway. For example, a view nested directly under an initial record may be changed as a configuring user toggles between interface configuration mode and interface rendering mode, and the view may appear to the configuring user as changed when the configuring user views the initial record or other records that have the view. For the other record, the information or field values relevant to the other records are shown rather than the information or field values for the initial record. In the context of quoting functionality, the record(s) may refer to transaction documents or quotes, and the record(s) may be further broken down into transaction lines, sections, attributes, or other sub-elements that describe or make up the record.

In one embodiment, views, sections, fields, or values may be displayed differently depending on conditions that are specified for the interface. The conditions may be persisted in the definition file(s) such that the definition file(s) result in displaying an interface with certain graphical elements when values of a record-in-view satisfy certain criteria, and may result in displaying another interface with other graphical elements, which may or may not partially overlap with the certain graphical elements, when values of a record-in-view do not satisfy the certain criteria and/or satisfy other criteria. In this manner, views, sections, fields, or values may be conditionally rendered, or rendered differently (e.g., full width or half-width, colored, grayed out, or not, etc.) depending on the value(s) being shown. In a specific example, an interface may show different field(s) for customers located in California than for customers in Arizona, and the interface may be adapted to show the different field(s) based on settings in the definition file(s) that specify which field(s) are to be shown under which condition(s). In this case, the condition would provide one interface version for records associated with customers where customer.state=“CA” and another interface version for records associated with customers where customer.state=“AZ”. In another example, the row width of a field may be varied from full-width or half-width based on the transaction number. For example, records with transaction numbers within a range may have the field shown at full-width, and other records may have the field shown at half-width. As another example, the font or color or font size may be varied depending on the field value. Although the conditions are not record-specific, the conditions may impact different records differently resulting in different versions of the interface being shown for different records.

The conditions may be specified in association with a view, section, or field, and may be stored as part of the definition file(s). The definition file(s) may have default conditions that are stored for certain fields based on settings that are provided whenever the field is initially configured in the interface management system, for example, as part of a data model. The conditions may be changed or overridden, or new conditions may be added, via an interface displayed in the interface configuration mode, to specify settings with respect to a view, section, or field. These updated conditions may be stored as part of the definition file(s).

The definition file(s) incorporate change(s) requested in the interface configuration mode that adhere to a custom technology- and/or platform- and/or framework-agnostic schema and would contain a collection of keys, each of which describe a part of the application structure. The interface management system and/or rendering application use the keys to reference the different parts of the application structure and their corresponding interface functionality when rendering the interface in the rendered interface mode. Updates made using the interface configuration mode involve adding specific components to sections of the definition file(s) and in the process merging the updates with the content defined in the plurality of sections identified by the universal identifier. An active user or other privileged user may view the updates provided in the interface configuration mode using the definition file(s) as updated in memory. Other users not involved in or privileged to make updates to the definition file(s) may view a user interface as a result of the updates to the definition file(s) when the definition file(s) are published by the active or other privileged user upon completion of making the updates in the interface configuration mode. When a viewer requests the page after updates have been published using the interface management system and/or another rendering application, the definition file(s) are retrieved by the viewing client with the original metadata and the new metadata or updated state in a corresponding position within a schema of keys to provide a consistent view of the interface across clients using the application. The metadata as arranged according to the structured interface schema defines the user interface, which may be customized by changing the metadata.

In one embodiment, a designer interface is used to generate a metadata model that may be consumed by an application instance at runtime to transform the metadata model to interface components that are shown on a displayed user interface. A user may switch back and forth between the designer interface in interface configuration mode and a runtime interface in interface rendering mode in order to test applications of the metadata model from the designer interface in the runtime interface.

In one embodiment, the application is defined to include a polymorphic model that can be interpreted and used by the interface management system or a rendering application to access data for features defined either at configuration time or at runtime. The polymorphic model includes unique identifiers specified within a schema, hierarchy, or other context of other unique identifiers that, together, define components that may be consumed to render an interface. These unique identifiers are included within the context of existing identifiers and metadata in a structured document to cause consistent rendering of a configured interface. Each feature of the interface is persisted as an abstract object definition under that identifier, within the structured document, and can subsequently be retrieved when an action is invoked that specifies a matching unique identifier. In this manner, the application's interface can be described agnostic of the technology and/or platform and/or framework that the application may run with. In one embodiment, the application schema is specified in a JSON format abstracted from the underlying technology.

In various embodiments, the interface management system may provide an immediate preview of the enterprise application layout customization in interface rendering mode, allowing administrators or other privileged users to see changes in real-time without the need for deployment. The interface management system may include an extensible model that can be applied to other products, such as but not limited to Product Configuration, Pricing, Order and Inventory Management, to enhance customization and preview capabilities across different modules. The interface management system utilizes advanced data fetching techniques, using a hierarchy of application rendering keys with defined characteristics, to promote faster and more seamless transitions between design and live modes and promote a smooth and efficient user experience.

In one embodiment, UI elements indicate the activation of or toggling between an interface rendering mode and an interface configuration mode, such as within a CPQ system. These UI elements may include toggles, buttons, or indicators that signify the transition between interface configuration and interface rendering modes. Users may interact with the interface rendering mode and interface configuration mode, and the interface management system may track user inputs which may be undone, redone, or otherwise analyzed to detect common patterns of configuration and rendering use.

### Interface Configuration Mode

In one embodiment, a configuration user interface is displayed when viewing a page in configuration mode. The configuration user interface shows which field(s) are included in which section(s) of the page, and what section(s) a view includes, and what view(s) the page includes. The configuration user interface also provides options for changing the way field(s), section(s), and view(s) are displayed on the page.

In some embodiments, the interface may support showing fields using a responsive design layout (where fields take up space as available on the screen), a one-column layout, a two-column layout, a three-column layout, a four-column layout, or any other layout as available layouts. Upon selection of a corresponding layout, the consumer-agnostic file may be updated by the interface management system to store a layout identifier in association with the section, and the layout identifier may be used to trigger display of the corresponding layout for the section whenever the page is loaded by the application based on the consumer-agnostic file.

The interface may also support various styles. For example, sections may show up as collapsible and expandable sections, one below another, such that the sections expand to show the fields within the section and collapse to hide the fields within the section. As another example, the sections may show up as horizontal tabs or as vertical tabs, where sections can be selected to show the fields within the selected section, hiding the other unselected sections. The horizontal tabs may be displayed along the top or bottom of the user interface region showing information about sections, and the vertical tabs may be displayed on the left or right of the region showing information about sections.

The style options provided by the interface management system may vary depending on a level of the key hierarchy for which the user is making changes in the configuration interface. For example, available styles at a view level may provide options to switch between horizontal tabs, vertical tabs, or collapsible sections; whereas, available styles at a section level beneath the view level may provide options to switch between showing field labels and field values horizontally one next to the other, vertically one above the other, or even without the field label at all. Available styles at a field level beneath the section level may provide options to stretch a field label and value across an entire row width or keep the field in the display settings (e.g., in N column(s)) as specified for the section or view, to show or hide a description of the field (i.e., a description of what values in the field represent, in addition to the value itself), etc.

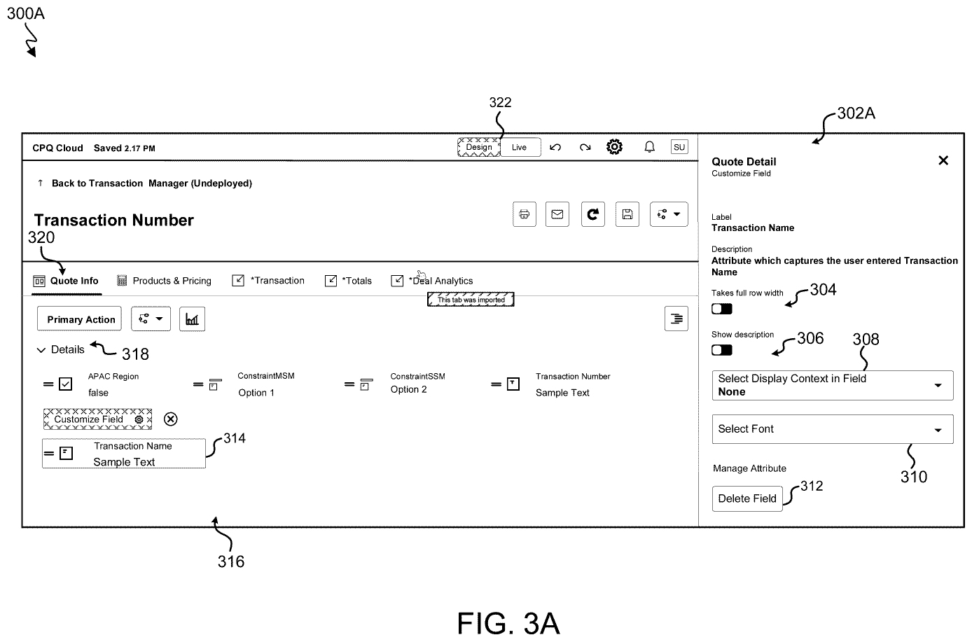

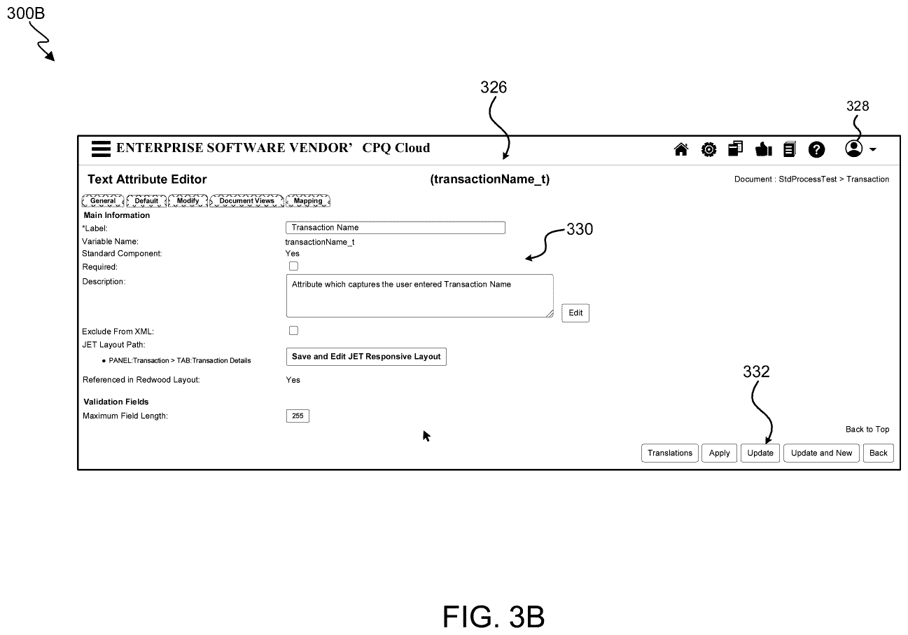

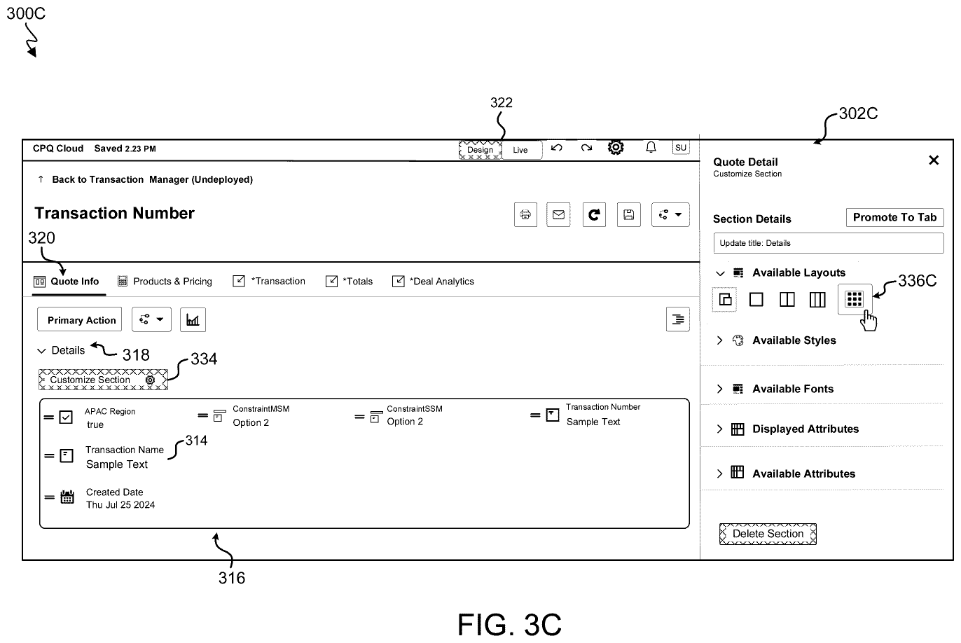

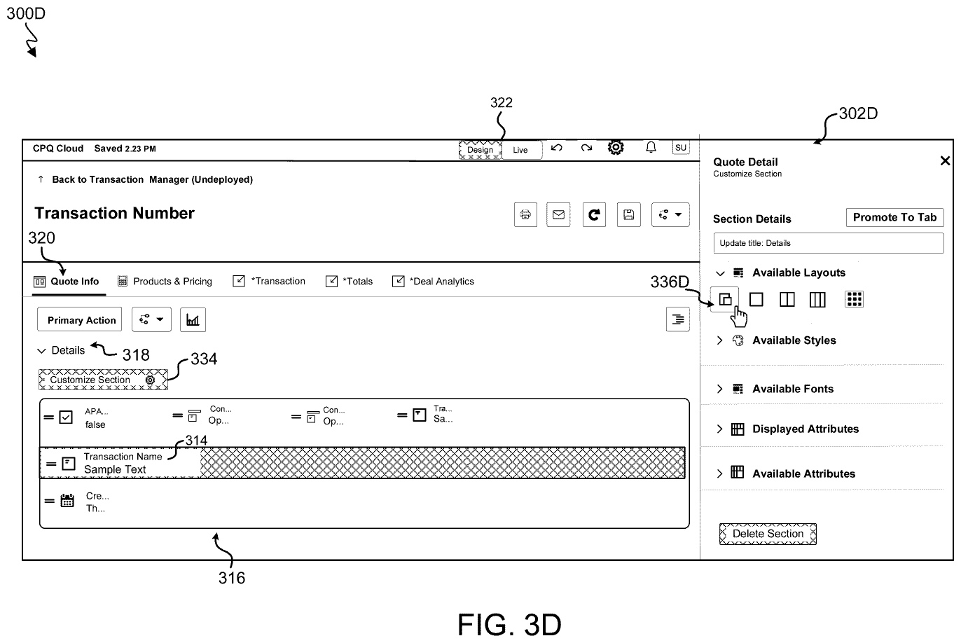

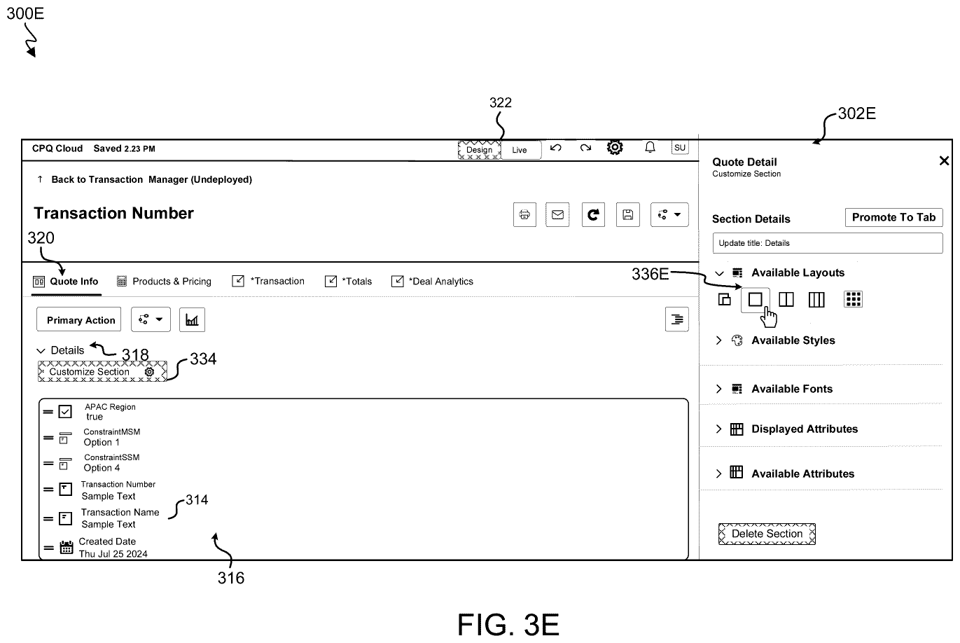

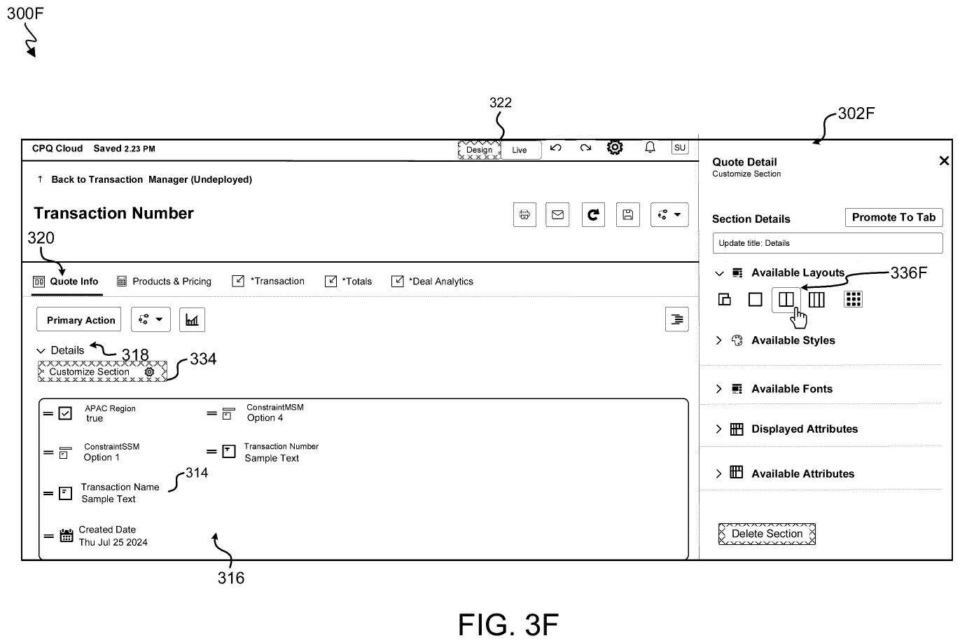

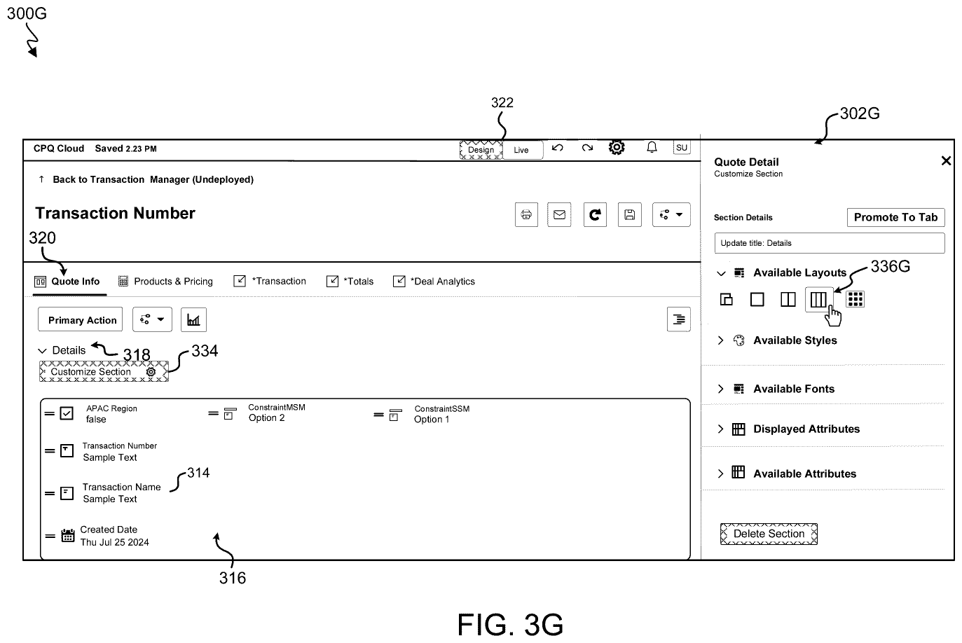

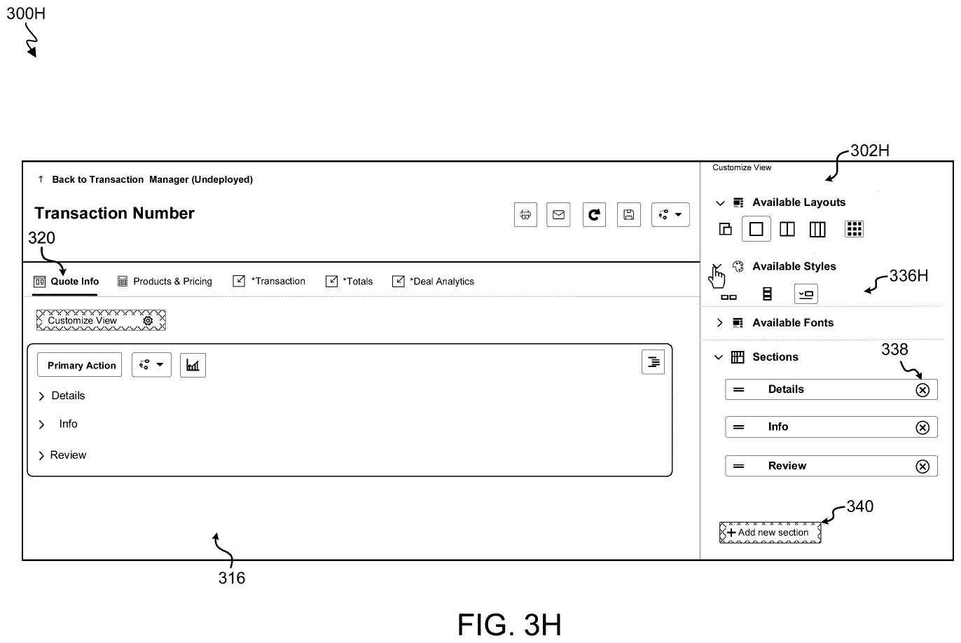

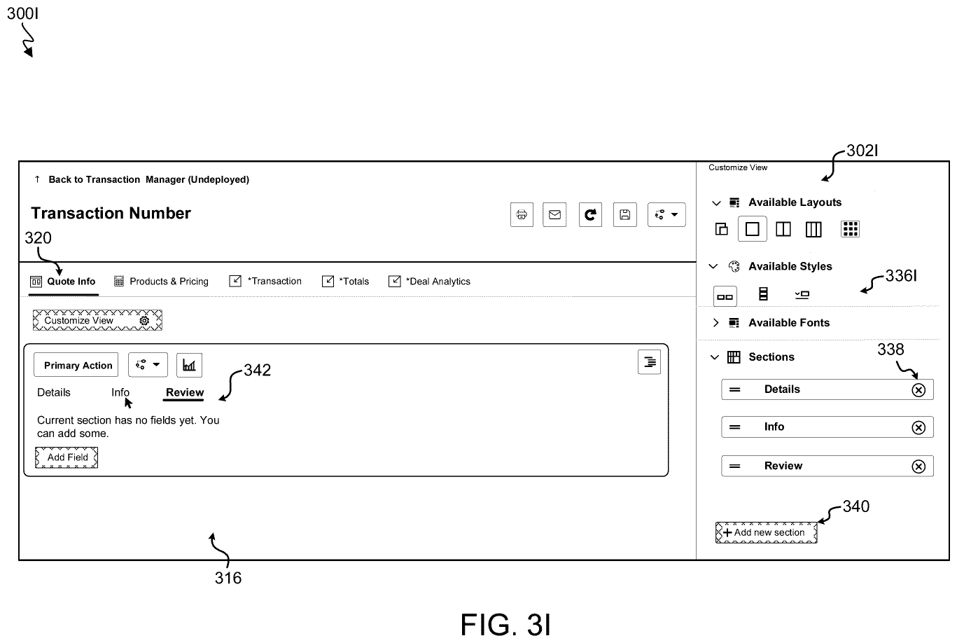

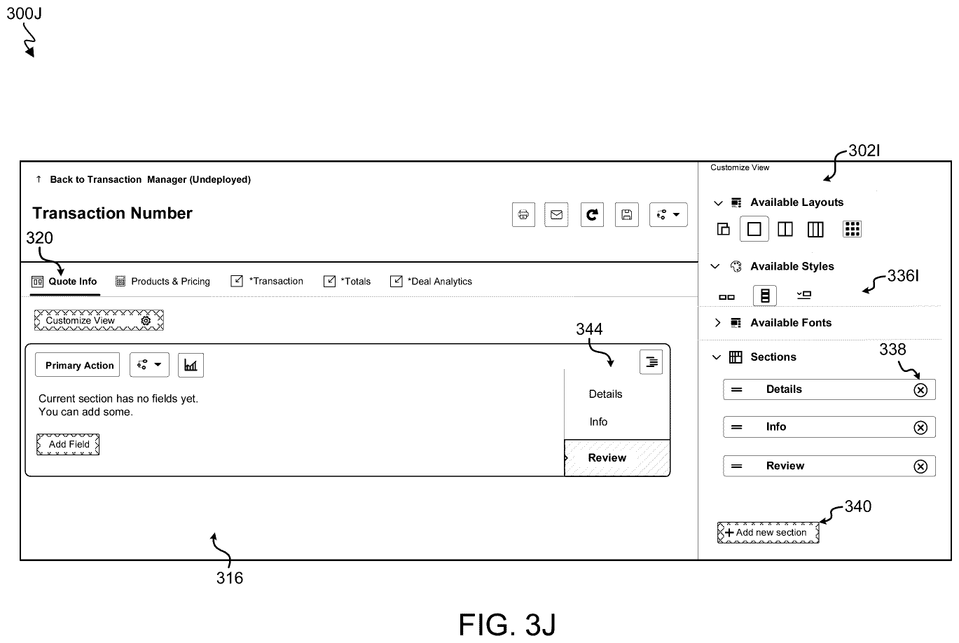

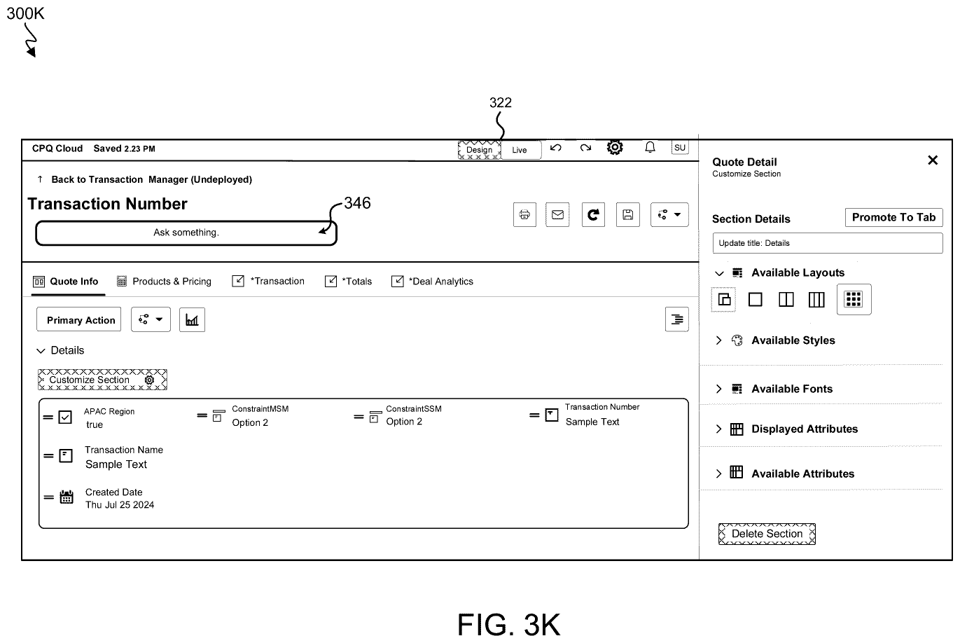

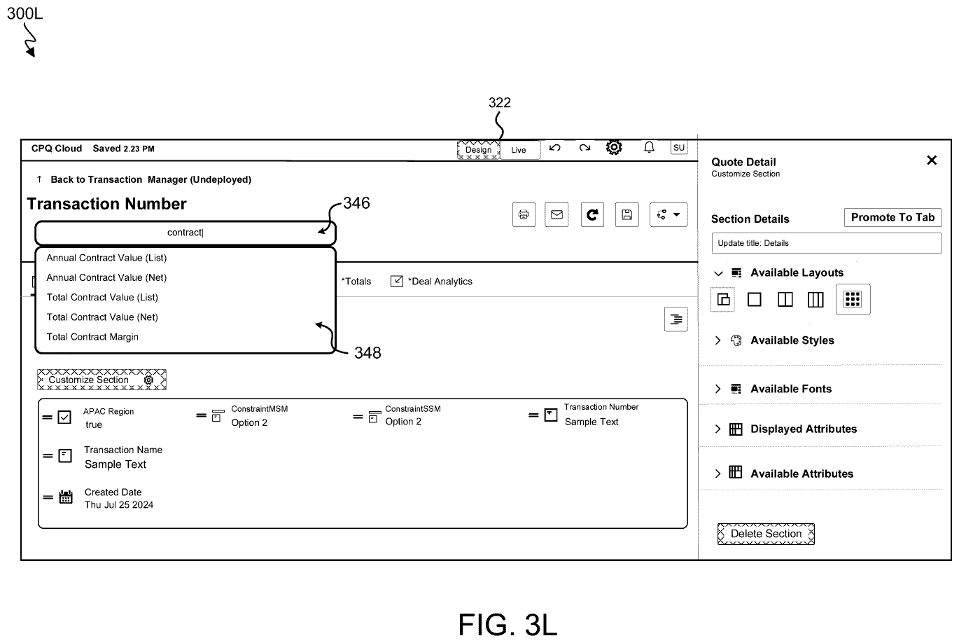

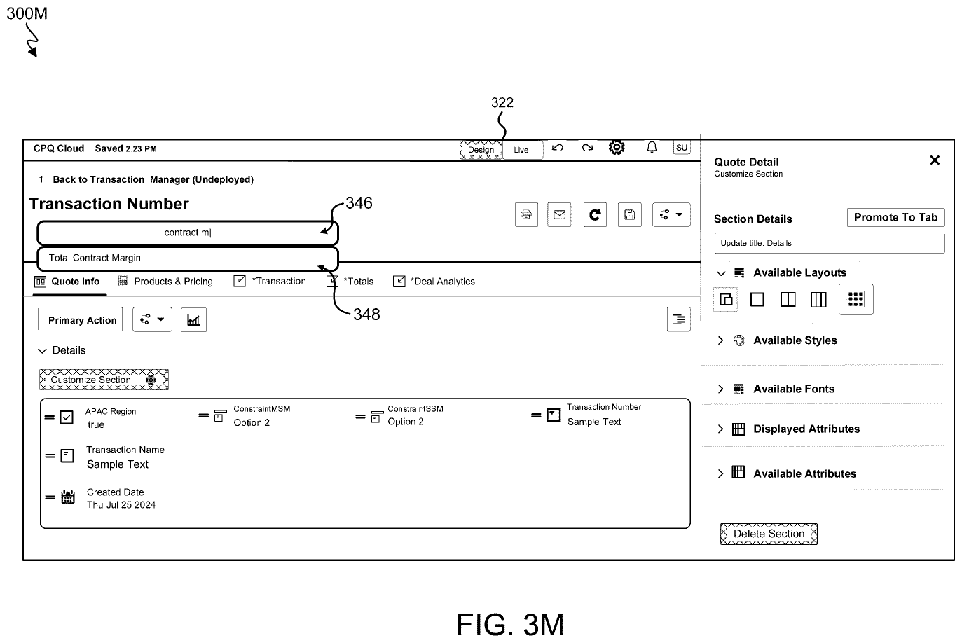

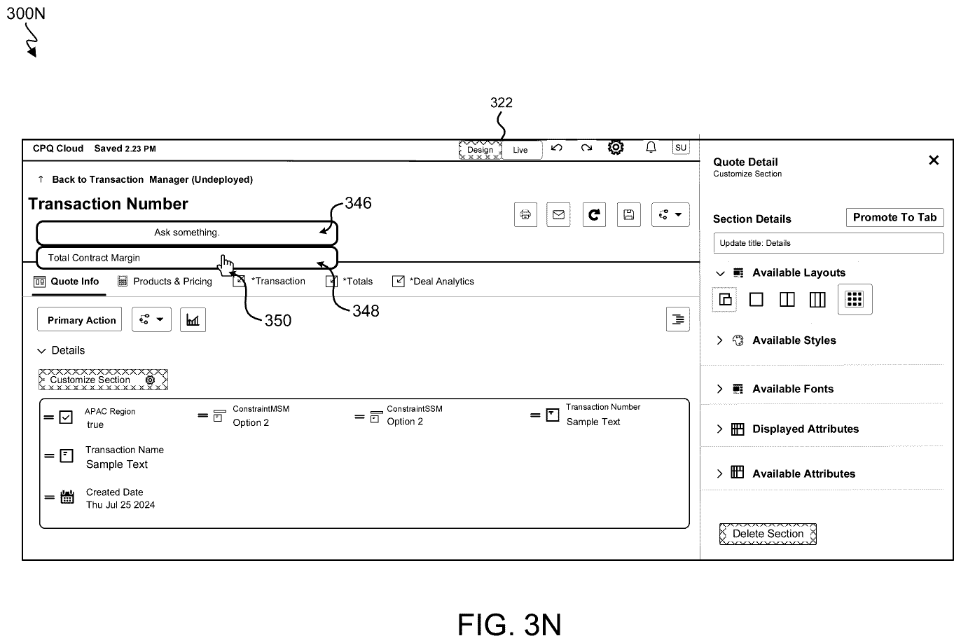

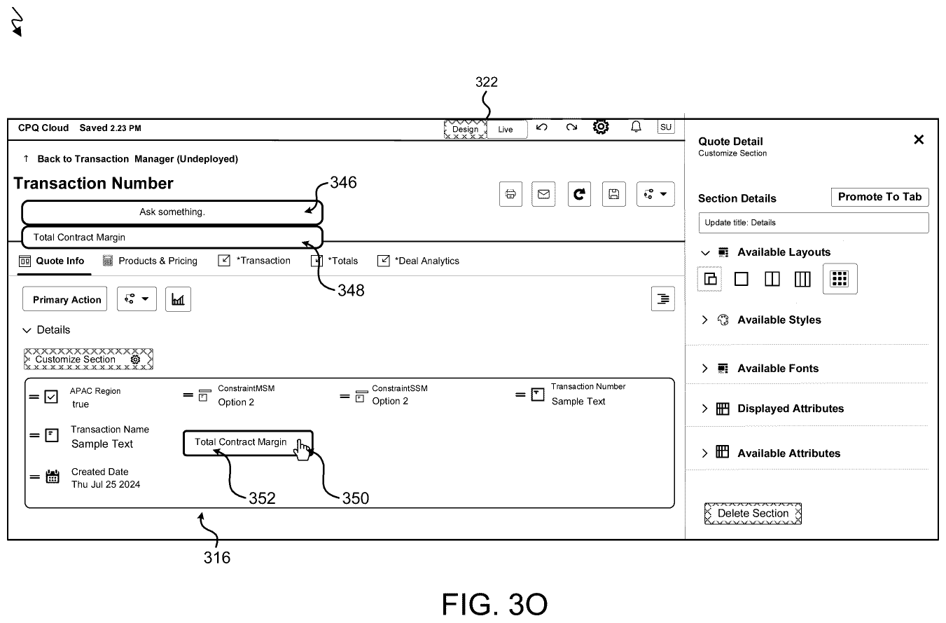

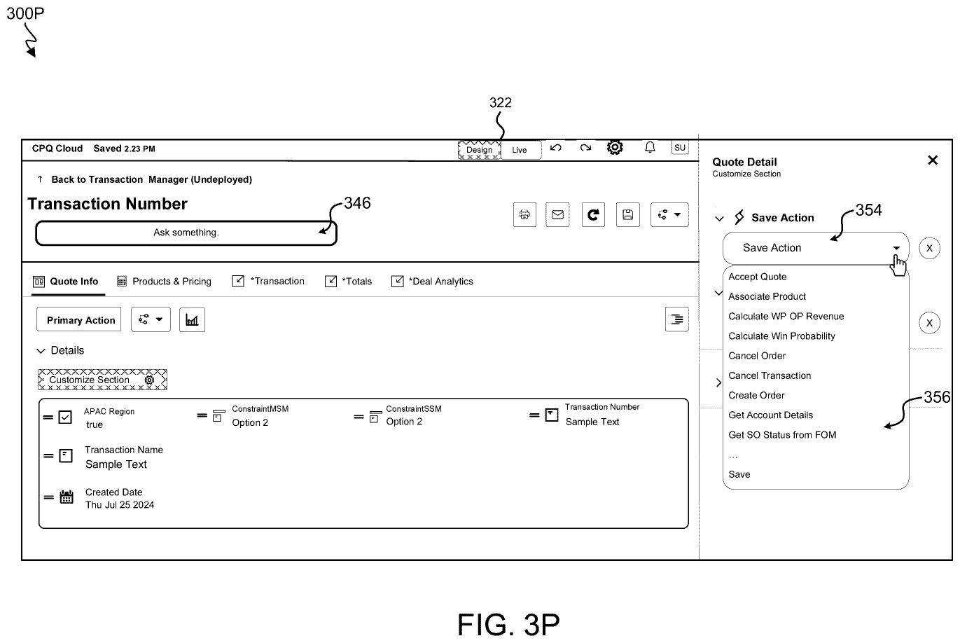

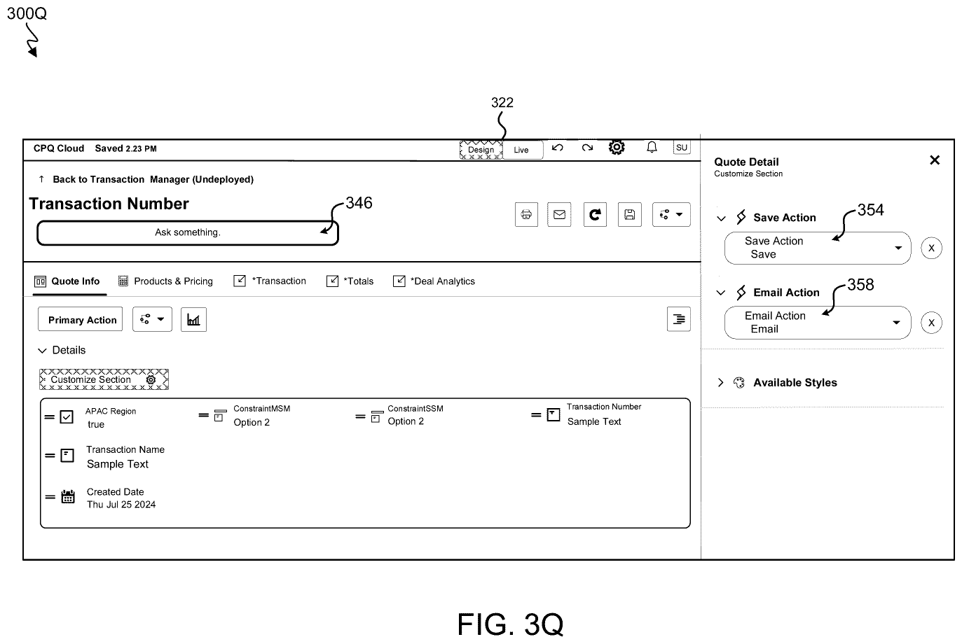

FIGS. 3A-3J, 4, 5, 6, 7, 8, and 9 illustrate example user interfaces available in interface configuration mode or interface rendering mode.

FIG. 3A shows an example configuration user interface 300A that includes options to adjust characteristic(s) of a field 314, Transaction Name, by selecting whether the field 314 takes full row width using option 304 and/or whether a description is shown when the field is displayed using option 306. A field customization region 302A includes options 304, 306, and option 308 to select a display context of the field 314, option 310 to select a font of the field 314, and an option 312 to delete field 314. Field 314 is shown in a location in a design layout region 316 of section 318 for view 320. A configuration mode is shown by the indication of “design” mode in view mode indicator 322.

FIG. 3B shows an example user interface 300B that includes options to edit an attribute 326 directly and specify additional details and restrictions 330 for the attribute 326. Control over an attribute 326 may depend on user roles and privileges. As shown, user 328 is logged into interface 300B for editing attribute 326. Changes may be saved using the update, apply, or update and new options 332.

FIG. 3C shows an example user interface 300C that includes a selected option 336C in section customization region 302C to use a layout characteristic for displaying four columns of fields in a section 318. Option 336C may be viewed by selecting a customize section option 334 under section 318 in design layout region 316 of FIG. 3C.

FIG. 3D shows an example user interface 300D that includes a selected option 336D in section customization region 302D to use a layout characteristic for displaying fields reactively based on the amount of data contained in the field. Option 336D may be viewed by selecting a customize section option 334 under section 318 in design layout region 316 of FIG. 3D.

FIG. 3E shows an example user interface 300E that includes a selected option 336E in section customization region 302E to use a layout characteristic for displaying one columns of fields in a section. Option 336E may be viewed by selecting a customize section option 334 under section 318 in design layout region 316 of FIG. 3E.

FIG. 3F shows an example user interface 300F that includes a selected option 336F in section customization region 302F to use a layout characteristic for displaying two columns of fields in a section. Option 336F may be viewed by selecting a customize section option 334 under section 318 in design layout region 316 of FIG. 3F.

FIG. 3G shows an example user interface 300G that includes a selected option 336G in section customization region 302G to use a layout characteristic for displaying three columns of fields in a section. Option 336G may be viewed by selecting a customize section option 334 under section 318 in design layout region 316 of FIG. 3G.

FIG. 3H shows an example user interface 300H that includes an option 336H to select a style characteristic where sections can be collapsed or expanded to show field(s) within the sections. As shown in region 316, sections are collapsed as indicated by option 336H. In addition to option 336H, customize view region 302H includes option 338H to re-order or delete sections in the view, as well as option 340 to add a new section to the view.

FIG. 3I shows an example user interface 300I that includes an option 336I to select a style characteristic where sections are selectable to be displayed alternately in horizontal tabs 342, where views such as view 320 are also selectable in horizontal tabs. As shown in region 316, the review section is shown in a horizontal tab as indicated by option 336I.

FIG. 3J shows an example user interface 300J that includes an option 336J to select a style characteristic where sections are selectable to be displayed alternately in vertical tabs 344, where views such as view 320 are selectable in horizontal tabs. As shown in region 316, the review section is shown in a vertical tab as indicated by option 336J

FIG. 3K shows an example configuration user interface 300K that includes an option for selecting from available fields using a natural language input. As shown, natural language input region 346 is displayed for receiving natural language user input.

FIG. 3L shows an example configuration user interface 300L that includes an option being used to select from among available fields shown that are matching, partially matching, or semantically similar to a natural language input. As shown, natural language input region 346 is used to enter partial information that matches field(s) available for display in the user interface. A drop-down menu 348 of available fields is shown for selecting a field to add to the user interface.

FIG. 3M shows an example configuration user interface 300M that includes an option being used to select a particular field shown that is matching, partially matching, or semantically similar to a natural language input. Based on input into input region 346, the menu 348 of available fields has been narrowed down to a desired field.

FIG. 3N shows an example configuration user interface 300N that includes an option being used to select a particular field shown based on natural language input. As shown, cursor 350 is being used to select an item from menu 348.

FIG. 3O shows an example configuration user interface 300O that includes an option being used to drag a particular field selected using a natural language input into a particular position in a user interface, to a location where the particular field will be shown if the example configuration user interface is transitioned to interface rendering mode. As shown, cursor 350 is used to drag a graphical indication of field 352 into region 316.

FIG. 3P shows an example configuration user interface 300P that includes an option being used to select a particular action to perform when a save option is selected for input to the natural language input region. As shown, a save action option 354 is selected, and a drop-down menu 356 of actions to be triggered is displayed for user selection of a triggerable action.

FIG. 3Q shows an example configuration user interface 300Q that includes an option showing selection of a save action to perform when a save option is selected and an email action to perform when an email option is selected for input to the natural language input region. As shown, a save action option 356 and an email action option 358 have been saved as “save” and “email,” respectively, indicating that the save action for natural language input region 346 is to save settings provided and the email action for natural language input region 346 is to send an email. The individual actions may be further configured in an action configuration interface.

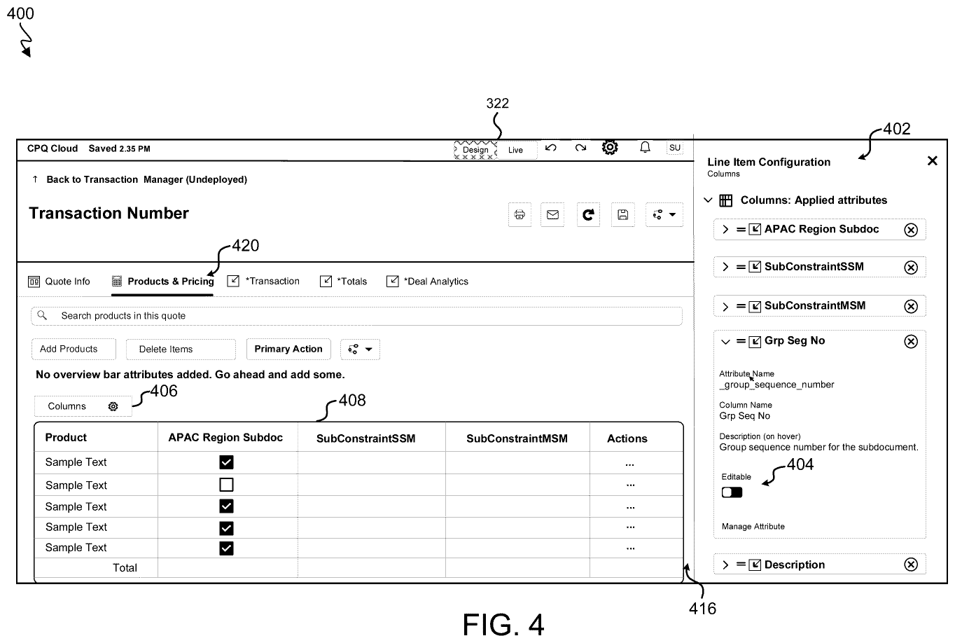

FIG. 4 shows an example user interface 400 that includes an option for showing a grid of items where columns are selectable for inclusion in the grid and columns are individually selectable as editable or not editable. As shown, line item configuration region 402 includes an option 404 for toggling whether a particular column is editable or not editable in a design layout region 416. Line item configuration options may be shown in response to a selection of column settings option 406 in relation to grid 408 displayed in region 416. In the example, grid 408 is part of view 420.

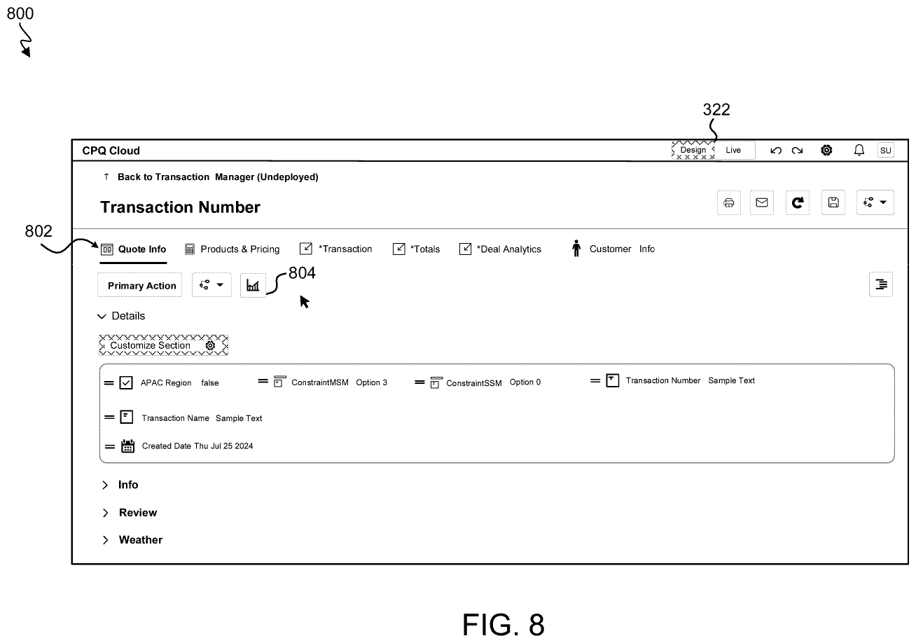

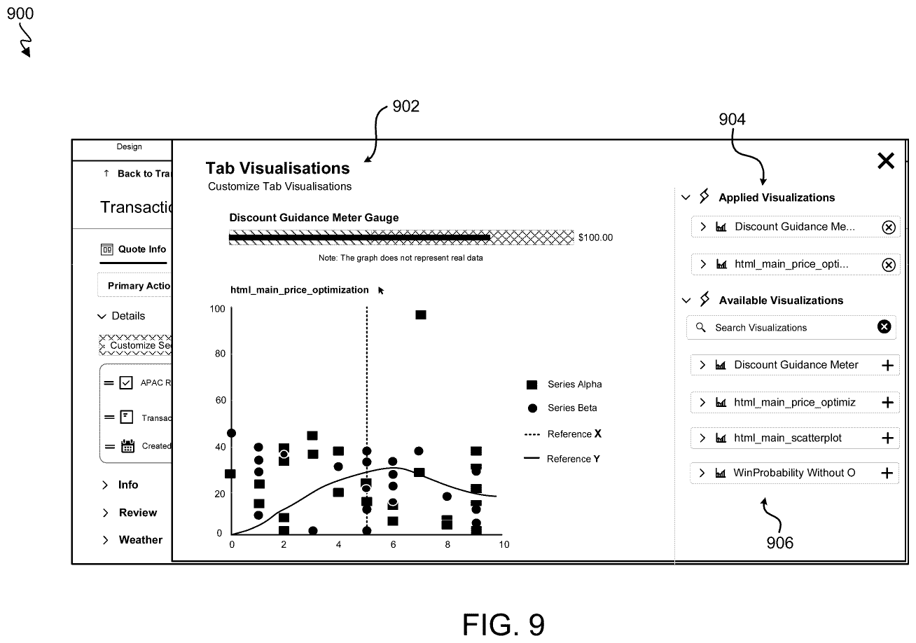

FIG. 8 shows an example user interface 800 that includes a rendering of a visualization option 804 in the Quote Info view 802, which is selectable in live mode to cause display of a visualization according to settings provided in configuration user interface 900 of FIG. 9, and selectable in design mode to cause options shown in configuration user interface 900 of FIG. 9.

FIG. 9 shows an example of a visualization configuration interface 900 that includes a customize tab visualizations option 902 for selecting visualizations to be applied 904 from available visualizations 906 when the visualization option 902 is selected. Each visualization may be further customized to select record(s) and/or column(s) to be included in the visualization.

### Consumer-Agnostic File

In one embodiment, the consumer-agnostic file is a structured document or other document with delimited hierarchical information. For example, the consumer-agnostic file may be a JSON document, an XML document, or Java classes, for example, and the consuming application may be configured to parse the consumer-agnostic file to determine features and elements of features for display on the user interface.

An example consumer-agnostic file is provided as an appendix hereto, which shows example components such as the components identified below.

The consumer-agnostic file may have keys, such as:
“configuration,” which identifies which components can be customized,
“header,” which shows a top of the interface,
“content,” which shows a main region of the interface,
“footer,” which shows a bottom of the interface,
Within the header and content sections, content types, such as “transaction” or “transaction line” to show records or parts of records.
Within the content, “views,” which show different regions of the interface that can be toggled on, off, made visible or hidden, shown in tabs, shown in panels, and/or made expandable or collapsible, etc. The views to include may be customized with different default names, icons, backgrounds, colors, fonts, and sizes, which may override defaults specified for the application.
Within the views, “sections,” which show different regions of a view that can be toggled on, off, made visible or hidden, shown in tabs, shown in panels, and/or made expandable or collapsible, etc. The sections to include may be customized with different default names, icons, backgrounds, colors, fonts, and sizes, which may override the defaults for the view.
Within the sections, “fields,” which show different fields that can take up full rows, be split into N columns, or shown responsive to how much information is included in the field such that fields with more data take up more space and fields with less data take up less space. The fields to include in a section may be selectable from an object model that lists available fields and may be shown with different icons, backgrounds, colors, fonts, and sizes, which may override the defaults for the section or view.
Within the sections, a “line item grid,” which shows different columns and rows in a table or report format based on settings that can be specified for the line item grid or columns thereof, including an option to specify which records are included in a collection of records to be shown in the line item grid, and options to specify whether values for specific columns are editable or not editable.
Within the header, within the content, within a view, within a section, or adjacent to a field, an “action” which shows an action such as:
   a record create, update, or delete action that may include multiple different orchestrated record creation, record updates (e.g., marking a sale as completed by changing the status of the quote and adjusting the agreed-upon price and quantity, retracting a quote by changing the status of the quote and updating an end-date for the quote, etc.), or record deletions,
   an undo operation that undoes a previous change,
   a redo operation that redoes a previous undone change,
   a notification action (e.g. triggering an email or text message to one or more users),
   a print action that prints to an attached printer or a digital format such as a pdf or jpg,
   a data input or output action, such as an export to comma-separated version (CSV) file or a Microsoft Excel (XLSX) format.
   a back action that navigates to another record previously viewed or a prior record in a list,
   a forward action that navigates to another record previously returned from or a next record in a list,
   a refresh action to refresh data shown on the record in case of any updates in a database that holds field values for the record,
   a save action to save changes to the record to the database,
   a submit or cancel action or other action to transition a record to a new state,
   a publication action to make a record available to other user(s) for review and/or approval,
   a request approvals action to trigger notification of other user(s) that approval is needed before the record may transition to a next state,
   a display action that shows certain information in an overlaid page, or
   any combination of actions. The actions may be specified as primary action(s) or other (“secondary”) action(s), with primary actions showing up with separate user-specifiable icons and/or buttons that consume space on the interface and secondary actions showing up in a drop-down or drill-down menu that consumes the same amount of space when not expanded regardless of how many actions are specified.
Within the header, within the content, within a view, within a section, or adjacent to a field, a “visualization” which shows a visualization such as:
   A meter or gauge that shows whether or how much of goal(s), target(s), or threshold(s) have been reached,
   A chart or graph that shows predefined and/or customizable combinations fields in a coordinate plane, pie graph, scatterplot, or other format, or
   Any combination of visualizations. The visualizations may be shown in the context of the record or a user-specified field of the record that was being viewed in the corresponding header, content, view, section, or field.
Within the header, within the content, within a view, within a section, or adjacent to a field, a “workflow” which specifies a series of processes or approvals that are triggered or required for a record, a field, or a combination of fields in the record, by a user, a type of user, a role of user, or a combination of users, before the record transitions to a target state. For example, the workflow may specify an ordered or unordered sequence or set of users that needs to approve the values before the record transitions to a target state. Workflows may also trigger other record update processes, third party processes, or other actions in the system. In one example, the interface management system may also have another workflow configuration interface for triggering workflows based on record updates, for example, to the database, independently of the interface through which those updates were made.

Keys may be associated objects that have, nested within the object specified by the key, a name such as a machine-referenced variable, an icon or other graphical element or visualization, a label such as a human-readable text, a type of a plurality of available types of objects corresponding to the key, a template and/or style, a corresponding action or process, a further nested object, and/or a unique id that uniquely identifies an instance of the object, for example.

The configuration interface may not show all possible options for modifying or configuring the consumer-agnostic file. For example, the configuration interface may show a subset of styles and a subset of layouts that can be selected, whether or not the consumer-agnostic file supports more than the selectable styles and layouts. In this manner, the consumer-agnostic file may be backward-compatible with configuration interfaces that provided other legacy configuration options no longer recommended or available in the configuration interface, by supporting the legacy style or layout identifier that is not normally available when making further changes via the configuration interface. For example, once a legacy style or layout is de-selected, the configuration interface may remove the legacy style or layout from the configuration interface for further changes. This transitions users to more modern interfaces without forcing users to make changes when changes are not otherwise needed.

In some embodiments, even if a layout, style or other configuration option is not available via user interface elements in the configuration interface, a configuring user with privileges to access and modify the consumer-agnostic file may view the consumer-agnostic file and make changes by directly editing text of the consumer-agnostic file to reference layouts, styles, or other configuration options that are not offered in the configuration interface.

Similarly, new styles or layouts or other configuration options may be added to the consumer-agnostic file in new releases such that new versions, releases, or updates of the application may support configuration options that were not present in previous versions, releases, or updates of the application. The application may operate in a backward-compatible manner such that default styles, layouts, or other configuration options are used when an existing application instance encounters an unknown style, layout, or other configuration option (for example, because the existing application instance has not yet been updated to recognize the configuration option), and also where updated application instances are still able to support legacy styles, layouts, or other configuration options that are no longer available in the configuration interface designed for the updated application instances.

In some embodiments, a legacy style, layout, or other configuration may be sunsetted, deprecated, or otherwise no longer supported by application instances. In these embodiments, a JSON schema validator or other schema validator may check the consumer-agnostic file to detect whether the consumer-agnostic file includes any sunsetted styles, layouts, or other configurations, and, if so, reject the consumer-agnostic file and revert to a previous version of the consumer-agnostic file that conformed to the accepted schema.

Updates to the consumer-agnostic file may be made in-place in the consumer-agnostic file, such that structured portions of the consumer-agnostic file relevant to the changes can be updated without updating other portions of the consumer-agnostic file.

### Seamless Switching Between Interface Configuration Mode and Interface Rendering Mode

When the user switches to the interface configuration mode from the interface rendering mode, the interface management system may access the data model available to the interface being displayed to determine which attributes are available for display on the interface even if the attributes have not yet been selected for inclusion on the interface. The data model may be stored in association with the application to which the interface belongs. The attributes selected for inclusion on the interface are determined from the consumer-agnostic file that was previously being used to view the interface in interface rendering mode.

The consumer-agnostic file may be stored in-memory in an application user's session when the consumer-agnostic file is being used to seamlessly switch between interface configuration mode and interface rendering mode. The in-memory version of the consumer-agnostic file may be used in place of a static version of the consumer-agnostic file stored on the server, such as a version published to other users. The in-memory version may reflect partial changes that have been made by a configuring user, and may be used to switch between interface rendering mode and interface configuration mode, with changes being inserted into respective portions of the consumer-agnostic file, which is stored in memory, as the changes are made.

In one embodiment, as the consumer-agnostic file is changed, the consumer-agnostic file is not only maintained in memory, but updates are made to a staged version of the consumer-agnostic file for other administrators or privileged users to be able to use for making changes to the interface that have not yet been published to other less privileged users. The staged version of the consumer-agnostic file may be maintained as a backup version of the in-memory version when only one user is making changes to the consumer-agnostic file. If multiple users are making changes to the consumer-agnostic file at the same time, their respective in-memory copies of staged version may be marked as clean or dirty for each user depending on whether changes have been made since the user last retrieved the consumer-agnostic file from the server. If the in-memory version of the consumer-agnostic file remains clean for the user, the user may continue to change the consumer-agnostic file using the in-memory version with updates being passed back to the staged version of the consumer-agnostic file that is marked as dirty for other users making changes. The other users may retrieve an updated version of the consumer-agnostic file from the server as the staged version, at which point their corresponding in-memory version of the consumer-agnostic file is marked as clean. Then, if further changes are made, the users not making the changes have their in-memory versions marked as dirty, prompting another retrieval of the staged version. In a particular embodiment, changes are sent back to the staged version of the consumer-agnostic file on the server as a modifying user switches from interface configuration mode to interface rendering mode.

In one embodiment, the in-memory version of the consumer-agnostic file is stored as a JavaScript object that is running as part of the application through an Internet browser environment, such as Edge®, Chrome®, or Safari®. In this example, the application running through the browser may retrieve the JavaScript object from the browser's memory without retrieving a refreshed version of the object from a server or an underlying database.

In one embodiment, the application instance supports undo and redo operations for changes that are being made in the interface configuration mode, and/or changes that were most recently made in the interface rendering mode. To support undo and redo operations, the application instance stores a log of changes that were made by a user in an application session as those changes relate to the consumer-agnostic document. In one example, the log is stored in memory as part of a JavaScript layer of the application instance running in a browser. The application instance may store a state of the consumer-agnostic document before the changes were made and after the changes were made as well as, for example, a timestamp of the change. The operations may be undone or redone in timestamp order such that the consumer-agnostic document is restored to a state that reflects the state of the consumer-agnostic document at the specified level of undo or redo.

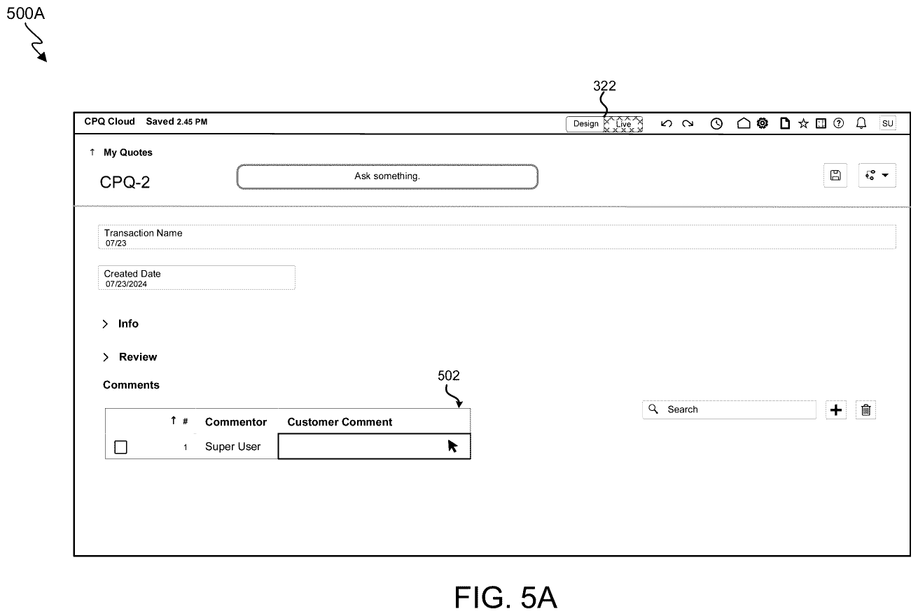

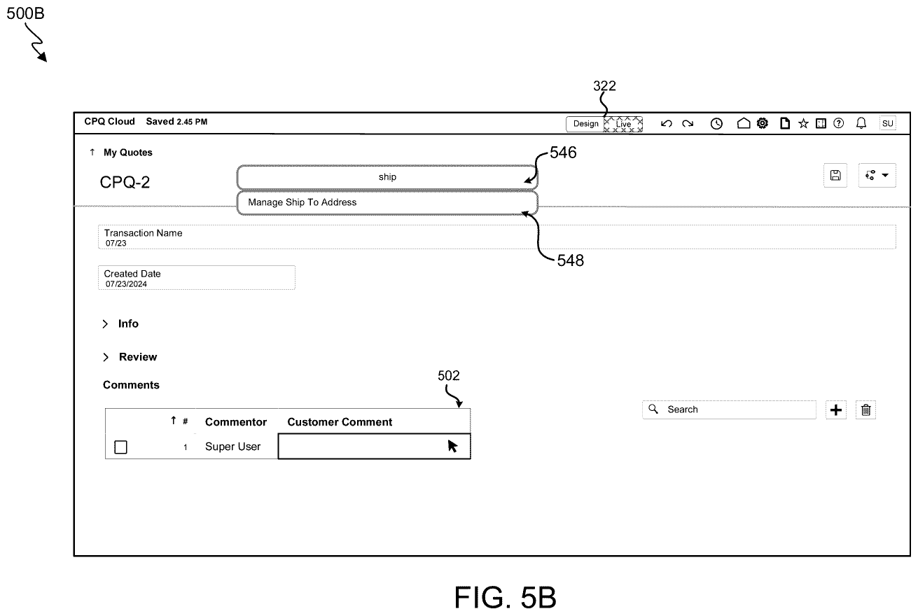

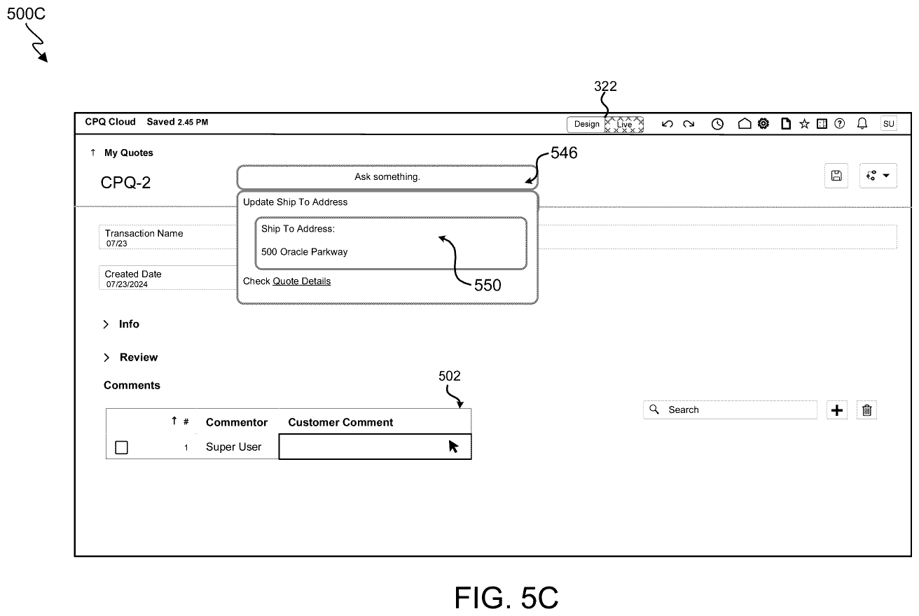

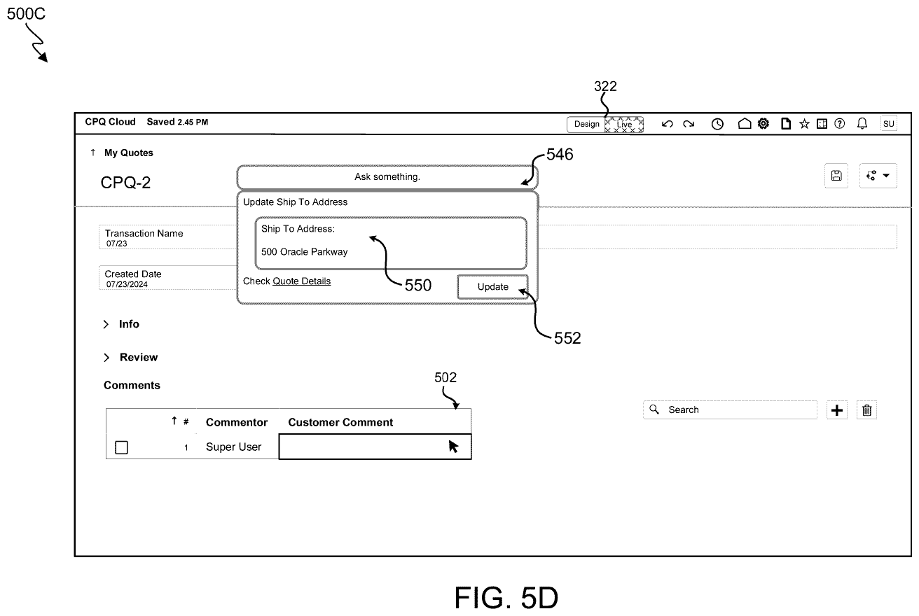

FIG. 5A shows an example rendered user interface 500A that includes a rendering of a line item grid 502 showing one item.

FIG. 5B shows an example rendered user interface 500B that includes an option in interface rendering mode being used to select a particular field shown in menu 548 that is matching, partially matching, or semantically similar to a natural language input provided in input region 546.

FIG. 5C shows an example rendered user interface 500C that includes an option 550 in interface rendering mode to edit a ship to address that is used in or behind-the-scenes (e.g., as part of an order submission when a submit option is selected) for one or more interfaces that are part of a hierarchical or navigable interface. A field may have been removed from all interfaces as a rare field but may still be editable via the natural language input, which may match against a full schema of available fields not just fields configured to be shown in rendered interfaces. As another example, an item selection interface might not show the ship to address, but an order submission interface may show the ship to address. The changes made using the interface of FIG. 5C may be applied to all interfaces that use the field for any user with access to the record in which the field value was set, without having to identify which interface(s) contain the field in order to find and edit the field.

FIG. 5D shows an example rendered user interface 500D that includes an option 552 in interface rendering mode to make an update that began with natural language user input. The update may be carried out according to the configuration settings determined in FIGS. 3P and 3Q.

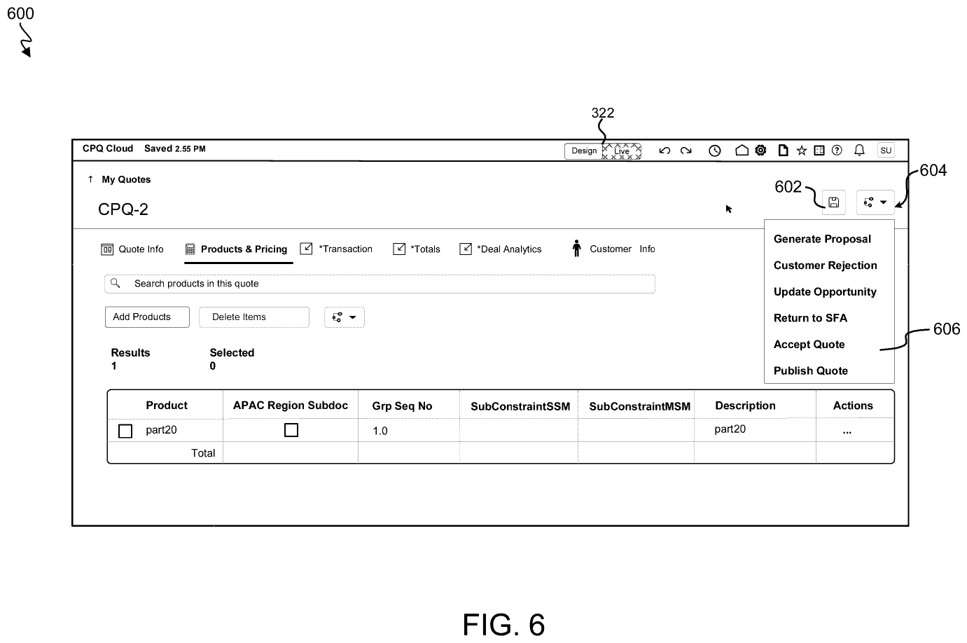

FIG. 6 shows an example user interface 600 that includes a rendering of a plurality of other or secondary actions 606 in addition to one primary save action 602 in a header, selectable for display using option 604.

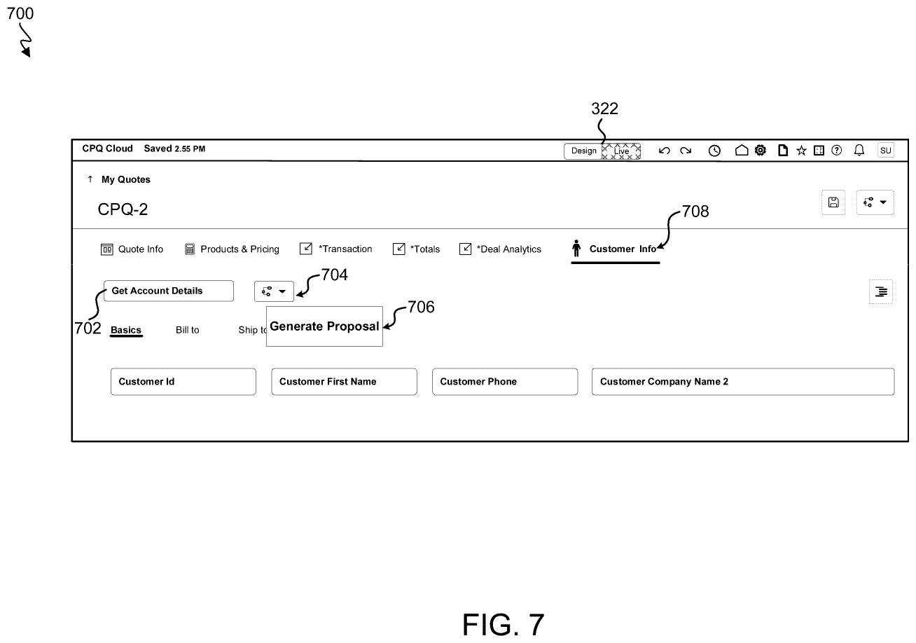

FIG. 7 shows an example user interface 700 that includes a rendering of another secondary action 706 in addition to one primary get account details action 702 for a Customer Info view 708, selectable for display using option 704.

### Efficient Fetching Using the Consumer-Agnostic File and Functionality-Driven Keys in a Hierarchy of Keys

When in the interface rendering mode, the record being viewed is fetched, and the consumer-agnostic file is also retrieved, for example from memory. The layout is bound to the consumer-agnostic file, and the interface is rendered based on the values of the record that was fetched in accordance with the privileges of the viewing user, or the user whom the viewing user is viewing on behalf of, to view the interface for the record on the display.

The application instance rendering the interface loads the consumer-agnostic file and recognizes the keys as critical components in the user interface. The application instance unwraps the consumer-agnostic file to determine the header, content, and footer, and, within the content, any views that are part of the content, within the views, any sections that are part of the views, and within the sections, any fields that are part of the sections. The corresponding parts are loaded by the application instance according to the configuration settings specified in the consumer-agnostic file, such as layouts, styles, fonts, visualizations, and actions to be included with the loaded portions of the consumer-agnostic file. The application instance takes these configuration settings as inputs to render the corresponding interface component consistently with the configuration settings of the consumer-agnostic file.

### Publication of Consumer-Agnostic File or Updates Thereto To Clients of a Cloud Application

In various embodiments, after changes have been made to the consumer-agnostic file by one or more users, the consumer-agnostic file may be published to a larger group of users as a production version of the consumer-agnostic file that is used to support the organization's ongoing processes. The production version of the consumer-agnostic file may replace a prior production version of the consumer-agnostic file, and the production version may be fetched instead of the prior version for any users who load an interface after the production version was published or otherwise made active.

### Computer System Architecture

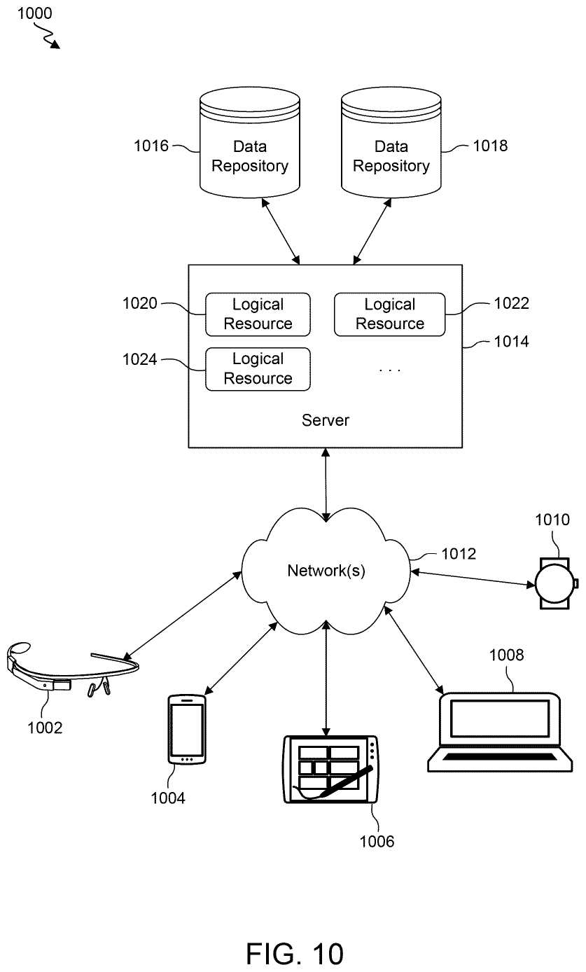

FIG. 10 depicts a simplified diagram of a distributed system 1000 for implementing an embodiment. In the illustrated embodiment, distributed system 1000 includes one or more client computing devices 1002, 1004, 1006, 1008, and/or 1010 coupled to a server 1014 via one or more communication networks 1012. Clients computing devices 1002, 1004, 1006, 1008, and/or 1010 may be configured to execute one or more applications.

In various aspects, server 1014 may be adapted to run one or more services or software applications that enable techniques for using a consumer-agnostic file to make and view changes to an interface that can be published for viewing by other users.

In certain aspects, server 1014 may also provide other services or software applications that can include non-virtual and virtual environments. In some aspects, these services may be offered as web-based or cloud services, such as under a Software as a Service (SaaS) model to the users of client computing devices 1002, 1004, 1006, 1008, and/or 1010. Users operating client computing devices 1002, 1004, 1006, 1008, and/or 1010 may in turn utilize one or more client applications to interact with server 1014 to utilize the services provided by these components.

In the configuration depicted in FIG. 10, server 1014 may include one or more components 1020, 1022 and 1024 that implement the functions performed by server 1014. These components may include software components that may be executed by one or more processors, hardware components, or combinations thereof. It should be appreciated that various different system configurations are possible, which may be different from distributed system 1000. The embodiment shown in FIG. 10 is thus one example of a distributed system for implementing an embodiment system and is not intended to be limiting.

Users may use client computing devices 1002, 1004, 1006, 1008, and/or 1010 for techniques for using a consumer-agnostic file to make and view changes to an interface that can be published for viewing by other users in accordance with the teachings of this disclosure. A client device may provide an interface that enables a user of the client device to interact with the client device. The client device may also output information to the user via this interface. Although FIG. 10 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 1012 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 1012 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 1014 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 1014 can include one or more virtual machines running virtual operating systems, or other computing architectures involving virtualization such as one or more flexible pools of logical storage devices that can be virtualized to maintain virtual storage devices for the server. In various aspects, server 1014 may be adapted to run one or more services or software applications that provide the functionality described in the foregoing disclosure.

The computing systems in server 1014 may run one or more operating systems including any of those discussed above, as well as any commercially available server operating system. Server 1014 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 1014 may include one or more applications to analyze and consolidate data feeds and/or event updates received from users of client computing devices 1002, 1004, 1006, 1008, and/or 1010. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1014 may also include one or more applications to display the data feeds and/or real-time events via one or more display devices of client computing devices 1002, 1004, 1006, 1008, and/or 1010.

Distributed system 1000 may also include one or more data repositories 1016, 1018. These data repositories may be used to store data and other information in certain aspects. For example, one or more of the data repositories 1016, 1018 may be used to store information for techniques for using a consumer-agnostic file to make and view changes to an interface that can be published for viewing by other users. Data repositories 1016, 1018 may reside in a variety of locations. For example, a data repository used by server 1014 may be local to server 1014 or may be remote from server 1014 and in communication with server 1014 via a network-based or dedicated connection. Data repositories 1016, 1018 may be of different types. In certain aspects, a data repository used by server 1014 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 1016, 1018 may also be used by applications to store application data. The data repositories used by applications may be of different types such as, for example, a key-value store repository, an object store repository, or a general storage repository supported by a file system.

In one embodiment, server 1014 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

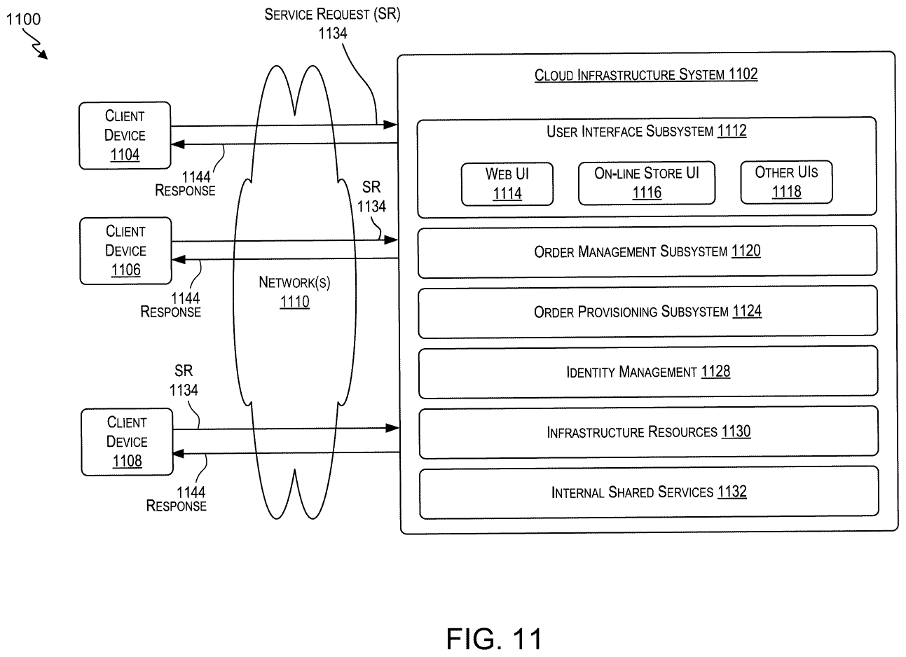

FIG. 11 is a simplified block diagram of a cloud-based system environment in which a consumer-agnostic file is used to make and view changes to an interface that can be published for viewing by other users, in accordance with certain aspects. In the embodiment depicted in FIG. 11, cloud infrastructure system 1102 may provide one or more cloud services that may be requested by users using one or more client computing devices 1104, 1106, and 1108. Cloud infrastructure system 1102 may comprise one or more computers and/or servers that may include those described above for server 1012. The computers in cloud infrastructure system 1102 may be organized as general purpose computers, specialized server computers, server farms, server clusters, or any other appropriate arrangement and/or combination.

Network(s) 1110 may facilitate communication and exchange of data between clients 1104, 1106, and 1108 and cloud infrastructure system 1102. Network(s) 1110 may include one or more networks. The networks may be of the same or different types. Network(s) 1110 may support one or more communication protocols, including wired and/or wireless protocols, for facilitating the communications.

The embodiment depicted in FIG. 11 is only one example of a cloud infrastructure system and is not intended to be limiting. It should be appreciated that, in some other aspects, cloud infrastructure system 1102 may have more or fewer components than those depicted in FIG. 11, may combine two or more components, or may have a different configuration or arrangement of components. For example, although FIG. 11 depicts three client computing devices, any number of client computing devices may be supported in alternative aspects.

The term cloud service is generally used to refer to a service that is made available to users on demand and via a communication network such as the Internet by systems (e.g., cloud infrastructure system 1102) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 1110 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 1102 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 1102 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 1102. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 1102. Cloud infrastructure system 1102 then performs processing to provide the services requested in the tenant's subscription order. Cloud infrastructure system 1102 may be configured to provide one or even multiple cloud services.

Cloud infrastructure system 1102 may provide the cloud services via different deployment models. In a public cloud model, cloud infrastructure system 1102 may be owned by a third party cloud services provider and the cloud services are offered to any general public tenant, where the tenant can be an individual or an enterprise. In certain other aspects, under a private cloud model, cloud infrastructure system 1102 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 1102 and the services provided may be shared by several organizations in a related community. Various other models such as hybrids of the above mentioned models may also be used.

Client computing devices 1104, 1106, and 1108 may be of different types (such as devices 402, 404, 406, and 408 depicted in FIG. 4) and may be capable of operating one or more client applications. A user may use a client device to interact with cloud infrastructure system 1102, such as to request a service provided by cloud infrastructure system 1102.

In some aspects, the processing performed by cloud infrastructure system 1102 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 1102 for determining the intent of an utterance. The data used for this analysis may include structured data (e.g., data stored in a database or structured according to a structured model) and/or unstructured data (e.g., data blobs (binary large objects)).

As depicted in the embodiment in FIG. 11, cloud infrastructure system 1102 may include infrastructure resources 1130 that are utilized for facilitating the provision of various cloud services offered by cloud infrastructure system 1102. Infrastructure resources 1130 may include, for example, processing resources, storage or memory resources, networking resources, and the like.

In certain aspects, to facilitate efficient provisioning of these resources for supporting the various cloud services provided by cloud infrastructure system 1102 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1102 may itself internally use services 1132 that are shared by different components of cloud infrastructure system 1102 and which facilitate the provisioning of services by cloud infrastructure system 1102. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1102 may comprise multiple subsystems. These subsystems may be implemented in software, or hardware, or combinations thereof. As depicted in FIG. 11, the subsystems may include a user interface subsystem 1112 that enables users of cloud infrastructure system 1102 to interact with cloud infrastructure system 1102. User interface subsystem 1112 may include various different interfaces such as a web interface 1114, an online store interface 1116 where cloud services provided by cloud infrastructure system 1102 are advertised and are purchasable by a consumer, and other interfaces 1118. For example, a tenant may, using a client device, request (service request 1134) one or more services provided by cloud infrastructure system 1102 using one or more of interfaces 1114, 1116, and 1118. For example, a tenant may access the online store, browse cloud services offered by cloud infrastructure system 1102, and place a subscription order for one or more services offered by cloud infrastructure system 1102 that the tenant wishes to subscribe to. The service request may include information identifying the tenant and one or more services that the tenant desires to subscribe to.

In certain aspects, such as the embodiment depicted in FIG. 11, cloud infrastructure system 1102 may comprise an order management subsystem (OMS) 1120 that is configured to process the new order. As part of this processing, OMS 1120 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 1120 may then invoke the order provisioning subsystem (OPS) 1124 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 1124 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 1102 may send a response or notification 1144 to the requesting tenant to indicate when the requested service is now ready for use. In some instances, information (e.g., a link) may be sent to the tenant that enables the tenant to start using and availing the benefits of the requested services.

Cloud infrastructure system 1102 may provide services to multiple tenants. For each tenant, cloud infrastructure system 1102 is responsible for managing information related to one or more subscription orders received from the tenant, maintaining tenant data related to the orders, and providing the requested services to the tenant or clients of the tenant. Cloud infrastructure system 1102 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 1102 may provide services to multiple tenants in parallel. Cloud infrastructure system 1102 may store information for these tenants, including possibly proprietary information. In certain aspects, cloud infrastructure system 1102 comprises an identity management subsystem (IMS) 1128 that is configured to manage tenant's information and provide the separation of the managed information such that information related to one tenant is not accessible by another tenant. IMS 1128 may be configured to provide various security-related services such as identity services, such as information access management, authentication and authorization services, services for managing tenant identities and roles and related capabilities, and the like.

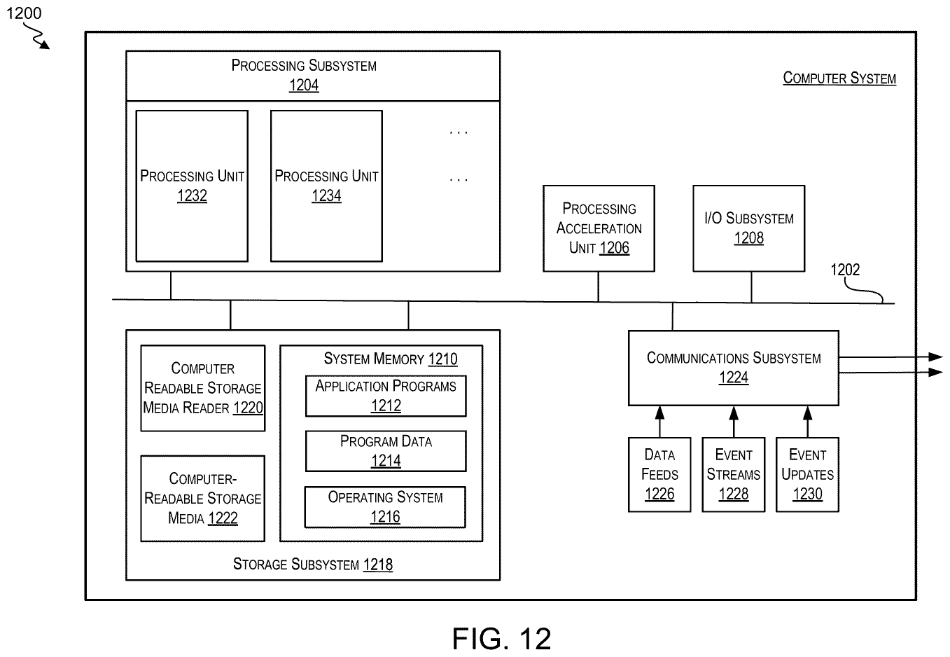

FIG. 12 illustrates an exemplary computer system 1200 that may be used to implement certain aspects. As shown in FIG. 12, computer system 1200 includes various subsystems including a processing subsystem 1204 that communicates with a number of other subsystems via a bus subsystem 1202. These other subsystems may include a processing acceleration unit 1206, an I/O subsystem 1208, a storage subsystem 1218, and a communications subsystem 1224. Storage subsystem 1218 may include non-transitory computer-readable storage media including storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative aspects of the bus subsystem may utilize multiple buses. Bus subsystem 1202 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1204 controls the operation of computer system 1200 and may comprise one or more processors, application specific integrated circuits (ASICs), or field programmable gate arrays (FPGAs). The processors may be single core or multicore processors. The processing resources of computer system 1200 can be organized into one or more processing units 1232, 1234, etc. A processing unit may include one or more processors, one or more cores from the same or different processors, a combination of cores and processors, or other combinations of cores and processors. In some aspects, processing subsystem 1204 can include one or more special purpose co-processors such as graphics processors, digital signal processors (DSPs), or the like. In some aspects, some or all of the processing units of processing subsystem 1204 can be implemented using customized circuits, such as application specific integrated circuits (ASICs), or field programmable gate arrays (FPGAs).

In some aspects, the processing units in processing subsystem 1204 can execute instructions stored in system memory 1210 or on computer readable storage media 1222. In various aspects, the processing units can execute a variety of programs or code instructions and can maintain multiple concurrently executing programs or processes. At any given time, some or all of the program code to be executed can be resident in system memory 1210 and/or on computer-readable storage media 1222 including potentially on one or more storage devices. Through suitable programming, processing subsystem 1204 can provide various functionalities described above. In instances where computer system 1200 is executing one or more virtual machines, one or more processing units may be allocated to each virtual machine.

In certain aspects, a processing acceleration unit 1206 may optionally be provided for performing customized processing or for off-loading some of the processing performed by processing subsystem 1204 so as to accelerate the overall processing performed by computer system 1200.

I/O subsystem 1208 may include devices and mechanisms for inputting information to computer system 1200 and/or for outputting information from or via computer system 1200. In general, use of the term input device is intended to include all possible types of devices and mechanisms for inputting information to computer system 1200. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1200 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1218 provides a repository or data store for storing information and data that is used by computer system 1200. Storage subsystem 1218 provides a tangible non-transitory computer-readable storage medium for storing the basic programming and data constructs that provide the functionality of some aspects. Storage subsystem 1218 may store software (e.g., programs, code modules, instructions) that when executed by processing subsystem 1204 provides the functionality described above. The software may be executed by one or more processing units of processing subsystem 1204. Storage subsystem 1218 may also provide a repository for storing data used in accordance with the teachings of this disclosure.

Storage subsystem 1218 may include one or more non-transitory memory devices, including volatile and non-volatile memory devices. As shown in FIG. 12, storage subsystem 1218 includes a system memory 1210 and a computer-readable storage media 1222. System memory 1210 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1200, such as during start-up, may typically be stored in the ROM. The RAM typically contains data and/or program modules that are presently being operated and executed by processing subsystem 1204. In some implementations, system memory 1210 may include multiple different types of memory, such as static random access memory (SRAM), dynamic random access memory (DRAM), and the like.

By way of example, and not limitation, as depicted in FIG. 12, system memory 1210 may load application programs 1212 that are being executed, which may include various applications such as Web browsers, mid-tier applications, relational database management systems (RDBMS), etc., program data 1214, and an operating system 1216. By way of example, operating system 1216 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1222 may store programming and data constructs that provide the functionality of some aspects. Computer-readable media 1222 may provide storage of computer-readable instructions, data structures, program modules, and other data for computer system 1200. Software (programs, code modules, instructions) that, when executed by processing subsystem 1204 provides the functionality described above, may be stored in storage subsystem 1218. By way of example, computer-readable storage media 1222 may include non-volatile memory such as a hard disk drive, a magnetic disk drive, an optical disk drive such as a CD ROM, digital video disc (DVD), a Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1218 may also include a computer-readable storage media reader 1220 that can further be connected to computer-readable storage media 1222. Reader 1220 may receive and be configured to read data from a memory device such as a disk, a flash drive, etc.

In certain aspects, computer system 1200 may support virtualization technologies, including but not limited to virtualization of processing and memory resources. For example, computer system 1200 may provide support for executing one or more virtual machines. In certain aspects, computer system 1200 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1200. Accordingly, multiple operating systems may potentially be run concurrently by computer system 1200.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to establish a communication channel to one or more client devices via the Internet for receiving and sending information from and to the client devices.

Communication subsystem 1224 may support both wired and/or wireless communication protocols. For example, in certain aspects, communications subsystem 1224 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1224 can provide wired network connectivity (e.g., Ethernet) in addition to or instead of a wireless interface.

Communication subsystem 1224 can receive and transmit data in various forms. For example, in some aspects, in addition to other forms, communications subsystem 1224 may receive input communications in the form of structured and/or unstructured data feeds 1226, event streams 1228, event updates 1230, and the like. For example, communications subsystem 1224 may be configured to receive (or send) data feeds 1226 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1224 may be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1224 may also be configured to communicate data from computer system 1200 to other computer systems or networks. The data may be communicated in various different forms such as structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1200 depicted in FIG. 12 is intended only as a specific example. Many other configurations having more or fewer components than the system depicted in FIG. 12 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
rendering, by a client device, a customized user interface for viewing information about a record at least in part by:
accessing, from a server, a published version of a consumer-agnostic file that defines a plurality of components of the customized user interface, wherein the plurality of components are identified among a structured set of keys, wherein one or more keys of the structured set of keys are associated with one or more corresponding interface regions and one or more other keys of the structured set of keys are associated with one or more characteristics of one or more components of the plurality of components, and wherein the one or more components are defined based at least in part on one or more fields of the record;
accessing, from the server, one or more values of the one or more fields from the record, and
generating one or more graphical elements in the one or more corresponding interface regions based at least in part on the one or more values and the one or more characteristics of the one or more components;
switching to a configuration mode of the customized user interface, and saving, in memory of the client device, an identity of the record;
receiving input to make one or more changes to the consumer-agnostic file;
storing the one or more changes in memory of the client device as a new version of the consumer-agnostic file without updating the published version of the consumer-agnostic file;
switching to a rendering mode of the customized user interface;
loading the new version of the consumer-agnostic file from memory without re-retrieving the published version of the consumer-agnostic file from the server;
rendering, by the client device, the customized user interface based at least in part on one or more values from the record and the new version of the consumer-agnostic file;
publishing a changed version of the consumer-agnostic file to replace the published version of the consumer-agnostic file, wherein publishing causes the changed version of the consumer-agnostic file to be newly accessible to one or more other users.

2. The computer-implemented method of claim 1, wherein the plurality of components comprise a plurality of view components each comprising one or more section components, and wherein the one or more characteristics indicate which user interface functionality of a plurality of candidate user interface functionalities is used to switch between viewing the plurality of view components.

3. The computer-implemented method of claim 1, wherein the plurality of components comprise a plurality of section components each comprising one or more field components, and wherein the one or more characteristics indicate how to arrange the one or more field components within the plurality of section components.

4. The computer-implemented method of claim 1, wherein the plurality of components comprise a plurality of section components, and wherein the one or more characteristics indicate which user interface functionality of a plurality of candidate user interface functionalities is used to concurrently view the plurality of section components.

5. The computer-implemented method of claim 1, wherein the plurality of components comprise a line item grid, and wherein the one or more characteristics indicate which records to include in the line item grid and which columns of the records to show in the line item grid.

6. The computer-implemented method of claim 1, wherein the plurality of components comprise an action component specified, in the consumer-agnostic file, as appearing directly in the customized user interface or as appearing in a drill-down menu of the customized user interface, wherein the action component is nested under one or more keys of the structured set of keys and causes performance of a process defined for the action component.

7. The computer-implemented method of claim 1, wherein the plurality of components comprise a visualization component nested under one or more keys of the structured set of keys, wherein the one or more characteristics indicate one or more columns that are featured in a visualization triggered by the visualization component.

8. The computer-implemented method of claim 1, wherein the plurality of components comprise a visualization component nested under one or more keys of the structured set of keys, wherein the one or more characteristics indicate one or more types of visualizations of a plurality of candidate types of visualizations.

9. The computer-implemented method of claim 1, wherein the plurality of components comprise an approval component to transition to an approved status, and wherein the one or more characteristics identify one or more approvers that can accomplish the transition via the customized user interface.

10. The computer-implemented method of claim 1, further comprising, before publishing the changed version:
receiving, at the server, the new version of the consumer-agnostic file from the client device;
saving, by the server, the new version of the consumer-agnostic file as a staged version of the consumer agnostic file;
marking one or more other versions of the consumer-agnostic file on one or more other client devices as dirty;
receiving one or more other changes to the consumer-agnostic file from one or more other client devices; and
generating the changed version based at least in part on the one or more changes and the one or more other changes.

11. A computer-program product comprising one or more non-transitory machine-readable storage media, including stored instructions configured to cause a computing system to perform a set of actions comprising:
rendering, by a client device, a customized user interface for viewing information about a record at least in part by:
accessing, from a server, a published version of a consumer-agnostic file that defines a plurality of components of the customized user interface, wherein the plurality of components are identified among a structured set of keys, wherein one or more keys of the structured set of keys are associated with one or more corresponding interface regions and one or more other keys of the structured set of keys are associated with one or more characteristics of one or more components of the plurality of components, and wherein the one or more components are defined based at least in part on one or more fields of the record;
accessing, from the server, one or more values of the one or more fields from the record, and
generating one or more graphical elements in the one or more corresponding interface regions based at least in part on the one or more values and the one or more characteristics of the one or more components;
switching to a configuration mode of the customized user interface, and saving, in memory of the client device, an identity of the record;
receiving input to make one or more changes to the consumer-agnostic file;
storing the one or more changes in memory of the client device as a new version of the consumer-agnostic file without updating the published version of the consumer-agnostic file;
switching to a rendering mode of the customized user interface;
loading the new version of the consumer-agnostic file from memory without re-retrieving the published version of the consumer-agnostic file from the server;
rendering, by the client device, the customized user interface based at least in part on one or more values from the record and the new version of the consumer-agnostic file;
publishing a changed version of the consumer-agnostic file to replace the published version of the consumer-agnostic file, wherein publishing causes the changed version of the consumer-agnostic file to be newly accessible to one or more other users.

12. The computer-program product of claim 11, wherein the plurality of components comprise a plurality of view components each comprising one or more section components, and wherein the one or more characteristics indicate which user interface functionality of a plurality of candidate user interface functionalities is used to switch between viewing the plurality of view components.

13. The computer-program product of claim 11, wherein the plurality of components comprise a plurality of section components each comprising one or more field components, and wherein the one or more characteristics indicate how to arrange the one or more field components within the plurality of section components.

14. The computer-program product of claim 11, wherein the plurality of components comprise an action component specified, in the consumer-agnostic file, as appearing directly in the customized user interface or as appearing in a drill-down menu of the customized user interface, wherein the action component is nested under one or more keys of the structured set of keys and causes performance of a process defined for the action component.

15. The computer-program product of claim 11, wherein the plurality of components comprise a visualization component nested under one or more keys of the structured set of keys, wherein the one or more characteristics indicate one or more columns that are featured in a visualization triggered by the visualization component.

16. The computer-program product of claim 11, wherein the set of actions further include additional actions performed before publishing the changed version, the additional actions comprising:
receiving, at the server, the new version of the consumer-agnostic file from the client device;
saving, by the server, the new version of the consumer-agnostic file as a staged version of the consumer agnostic file;
marking one or more other versions of the consumer-agnostic file on one or more other client devices as dirty;
receiving one or more other changes to the consumer-agnostic file from one or more other client devices; and
generating the changed version based at least in part on the one or more changes and the one or more other changes.

17. A system comprising:
one or more processors;
one or more non-transitory computer-readable media storing instructions, which, when executed by the system, cause the system to perform a set of actions comprising:
rendering, by a client device, a customized user interface for viewing information about a record at least in part by:
accessing, from a server, a published version of a consumer-agnostic file that defines a plurality of components of the customized user interface, wherein the plurality of components are identified among a structured set of keys, wherein one or more keys of the structured set of keys are associated with one or more corresponding interface regions and one or more other keys of the structured set of keys are associated with one or more characteristics of one or more components of the plurality of components, and wherein the one or more components are defined based at least in part on one or more fields of the record;
accessing, from the server, one or more values of the one or more fields from the record, and
generating one or more graphical elements in the one or more corresponding interface regions based at least in part on the one or more values and the one or more characteristics of the one or more components;
switching to a configuration mode of the customized user interface, and saving, in memory of the client device, an identity of the record;
receiving input to make one or more changes to the consumer-agnostic file;
storing the one or more changes in memory of the client device as a new version of the consumer-agnostic file without updating the published version of the consumer-agnostic file;
switching to a rendering mode of the customized user interface;
loading the new version of the consumer-agnostic file from memory without re-retrieving the published version of the consumer-agnostic file from the server;
rendering, by the client device, the customized user interface based at least in part on one or more values from the record and the new version of the consumer-agnostic file;
publishing a changed version of the consumer-agnostic file to replace the published version of the consumer-agnostic file, wherein publishing causes the changed version of the consumer-agnostic file to be newly accessible to one or more other users.

18. The system of claim 17, wherein the plurality of components comprise a plurality of view components each comprising one or more section components, and wherein the one or more characteristics indicate which user interface functionality of a plurality of candidate user interface functionalities is used to switch between viewing the plurality of view components.

19. The system of claim 17, wherein the plurality of components comprise a plurality of section components each comprising one or more field components, and wherein the one or more characteristics indicate how to arrange the one or more field components within the plurality of section components.

20. The system of claim 17, wherein the plurality of components comprise an action component specified, in the consumer-agnostic file, as appearing directly in the customized user interface or as appearing in a drill-down menu of the customized user interface, wherein the action component is nested under one or more keys of the structured set of keys and causes performance of a process defined for the action component.

21. The system of claim 17, wherein the plurality of components comprise a visualization component nested under one or more keys of the structured set of keys, wherein the one or more characteristics indicate one or more columns that are featured in a visualization triggered by the visualization component.

22. The system of claim 17, wherein the set of actions further include additional actions performed before publishing the changed version, the additional actions comprising:
receiving, at the server, the new version of the consumer-agnostic file from the client device;
saving, by the server, the new version of the consumer-agnostic file as a staged version of the consumer agnostic file;
marking one or more other versions of the consumer-agnostic file on one or more other client devices as dirty;
receiving one or more other changes to the consumer-agnostic file from one or more other client devices; and
generating the changed version based at least in part on the one or more changes and the one or more other changes.
